(19) United States
(12) Patent Application Publication
(10) Pub. No.: US 2017/0177140 A1
(43) Pub. Date: Jun. 22, 2017

(54) TOUCH DEVICE USING THUMB

(71) Applicant: Ju Hyup LEE, Suwon-si (KR)

(72) Inventor: Ju Hyup LEE, Suwon-si (KR)

(21) Appl. No.: 15/115,979

(22) PCT Filed: Feb. 10, 2015
(86) PCT No.: PCT/KR2015/001300

§ 371 Date: Aug. 2, 2016

(30) Foreign Application Priority Data
Feb. 11, 2014 (KR) 10-2014-0015228

(51) Int. Cl. G06F 3/041; G06F 3/0354; G06F 3/0488

(52) U.S. Cl. CPC G06F 3/0416; G06F 3/04886; G06F 3/03547; G06F 2203/0339

(57) ABSTRACT

A touch device includes: a touch input module including a selection unit configured such that a selection is made therein and a sensing unit provided to generate a predetermined signal corresponding to the selection; a memory unit for storing data; and a control unit for processing the signal; wherein data execution is performed in the touch input module which is provided such that the selection of different sensing regions of the sensing unit, including indication locations respectively spaced apart at a predetermined distance, by a selection means is made within a range corresponding to a fingerprint region of one thumb. Accordingly, the present invention has the advantage of easily and quickly performing data execution in which one or more of data input and data control are performed through an intuitive selection of at least one indication location or sensing region by a single finger.

### BACKGROUND OF THE INVENTION

1. Field of the Invention

The present invention relates to a touch execution device. That is, the present invention relates to a touch execution device that is provided so that, in a device which detects the contact of a selection means upon selection by the selection means and enables data execution to be performed, a selection by the selection means including a finger is made in a selection unit and the execution of data assigned to a signal generated through the detection of the contact upon selection is performed.

2. Description of Related Art

Recently, the demands of users for touch execution devices that enable data input or data control to be executed in electronic devices and the like have been further diversified.

Providers who provide touch execution devices have increased the levels of completion of the touch execution devices in response to the demands of users through the upgrading of the usability, convenience, industrial application and the like of the touch execution devices, and have competitively developed and supplied various types of electronic devices or touch execution devices for specializing the electronic devices.

As an example, the “data input apparatus” of Korean Patent No. 10-0777653 (registered on Nov. 13, 2007) is disclosed.

The data input apparatus of the above patent invention has a configuration in which input switches in each of which a push-button switch and a contact switch are provided in an integrated manner are arranged in an n×m matrix, four adjacent input switches are assigned to a single unit cell, and input switches on boundary lines between neighboring unit cells are shared so that the unit cells are assigned in an (n−1)×(m−1) matrix.

That is, in the data input apparatus of the above patent invention, two or more input switches including switches in a diagonal direction within a unit cell are simultaneously touched. Accordingly, when an input signal is input from a contact switch, a unit cell including the touched input switch is activated. When a signal is received from a push button switch by the pressing operation of any one input switch forming the activated unit cell, a key value assigned to the input switch within the activated unit cell is input. The unit cell activated through the touching of the contact switch remains activated until a neighboring unit cell sharing the input switch is activated.

According to the patent invention, in the data input apparatus, data input can be executed only when at least two predetermined selection steps including the step of activating a unit cell including an input switch are performed.

That is, in the data input apparatus, problems arise in that data input cannot be rapidly performed and the execution of successive data input or various types of data input is not easy.

Furthermore, the data input apparatus has a structure in which input switches in each of which a push button switch and a contact switch are provided on a plate in an integrated manner are arranged in an n×m matrix.

That is, the plurality of input switches arranged in the n×m matrix does not correspond to a stricture in which the input switches are located in a region with which the fingerprint of a single thumb comes into contact based on the fingerprint of the single thumb.

Accordingly, a problem arises in that it is difficult for the plurality of input switches to be intuitively recognized by a single finger located on the plate.

Furthermore, in the data input apparatus, each of the plurality of input switches arranged in the n×m matrix has a structure in which a push button switch and a contact switch are provided in an integrated manner.

That is, in the data input apparatus, a problem arises in that it is not easy to successively and accurately perform one or more of data input adapted to input a character, a number or a symbol and data control adapted to include menu changing, mode switching or a keyboard function without mistyping.

Furthermore, according to the plurality of input switches provided in the data input apparatus, problems arise in that excessive force may be applied to a finger of a user who repeatedly performs one or more of data input and data control or who successively performs two or more tasks in a mixed manner and a damage may be caused to the finger's health because fatigue is accumulated on the finger.

As another example, the “data input device” of Korean Patent No. 10-0994362 (registered on Nov. 9, 2010) is disclosed.

The data input device of the above patent invention is a data input device including a specific sensing region in a terminal for an electronic device.

That is, the data input device has a configuration including an input unit which distinguishes and detects contacts or presses for a reference location whose location can be displaced in the sensing region and for a plurality of first indication locations radially disposed around the reference location and then generates input signals corresponding to the contacts or presses; and a control unit which determines the contact, pressing point or pressing direction of a finger from each of the input signals, extracts data assigned to the input signal from a memory unit, and inputs the extracted data.

Furthermore, the input unit distinguishes first outward moving input that moves toward any one of the plurality of first indication locations in the state in which the reference location has been touched, second outward moving input that moves outward toward any one of the plurality of first indication locations in the state in which the reference location has not been touched, first inward moving input that moves from any one of the plurality of first indication locations until the reference location is touched, and second inward moving input that moves inward from any one of the plurality of first indication locations until the reference location is touched from one another, and generates a corresponding input signal.

According to the above patent invention, in data execution including data input or data control performed by a selection made in the input unit, it is necessary to perform the selection while distinguishing the contacts and the presses for the reference location and the plurality of first indication locations radially disposed around the reference location from one another.

That is, a problem arises in that a user needs to separately learn the four selection operations (the first outward moving input, the second outward moving input, the first inward moving input, and the second inward moving input) so that the user can perform the four selection operations while distinguishing them from one another in the selection.

Furthermore, in the selection, if two or more of the four selection operations are successively performed or are repeatedly performed in a mixed manner using a single finger, problems arise in that a finger's concentration is reduced due to the selection operations, the accuracy of the data execution is decreased, and a mistyping rate is increased.

Furthermore, a problem arises in that a user′ stress may be increased in the data execution performed by the two or more selection operations because a user's high concentration is required in the two or more selection operations.

In order to overcome the above-described problems, there is a need for the invention of a touch execution device, which: includes an input unit having a structure that enables a selection by a selection means to be performed within a region corresponding to the fingerprint of a single thumb: enables different sensing regions, provided to, based on a selection by the single thumb performed in the input unit, detect the contact of a finger corresponding to the selection and generate a specific signal, to be respectively recognized as a selection location on one side and a selection location on the other side which are different from each other within a region with which the fingerprint of the finger comes into contact based on the selection by the single thumb and, simultaneously, to be recognized a location corresponding to a selection between the one and other sides; and enables data execution adapted to execute one or more of data input and data control to be performed through an intuitive selection of a selection location, recognized upon selection, by a single finger.

### SUMMARY OF THE INVENTION

The present invention is intended to overcome the above-described problems of the conventional arts, and an object of the present invention is to provide a touch execution device, which: includes an input unit having a structure that enables a selection by a selection means to be performed within a region corresponding to the fingerprint of a single thumb: enables different sensing regions, provided to, based on a selection by the single thumb performed in the input unit, detect the contact of a finger corresponding to the selection and generate a specific signal, to be respectively recognized as a selection location on one side and a selection location on the other side which are different from each other within a region with which the fingerprint of the finger comes into contact based on the selection by the single thumb and, simultaneously, to be recognized a location corresponding to a selection between the one and other sides; and enables data execution adapted to execute one or more of data input and data control to be performed through an intuitive selection of a selection location, recognized upon selection, by a single finger.

As a technical solution for accomplishing the above objects of the present invention, according to a first aspect of the present invention, there is presented a touch execution device using a thumb, which is provided such that a selection by a selection means including a finger is made in a selection unit and data execution assigned to a signal generated by detection of a contact upon selection is performed, the touch execution device including: at least one touch input module including a selection unit configured to enable the selection to be made by a single finger and a sensing unit provided to generate the signal in response to the selection; wherein in the touch input module: the selection unit is provided in a specific size within a range capable of corresponding to a fingerprint of the single thumb; the sensing unit includes a sensing region provided to generate a specific signal through detection of a contact of the finger upon selection, and the sensing region includes a first sensing region and a second sensing region formed to have regions each having a specific width and length on one and remaining sides of the touch input module, respectively, and located to face each other, based on a single thumb located at a central portion of the selection unit in the touch input module, a first indication location which is a reference location of the first sensing region and a second indication location which is a reference location of the second sensing region are located within a range in which the first indication location and the second indication location come into contact with a fingerprint of the thumb together, and the first indication location and the second indication location are respectively recognized as a selection location on one side of the selection unit and a selection location on an a remaining side of the selection unit which are spaced apart from each other at a specific interval on one axis in one direction which passes through the first sensing region and the second sensing region and, simultaneously, are recognized as an interval selection location corresponding to a selection of a location between the one and other sides by the thumb; based on a single selection operation performed by a single thumb in the touch input module: when the selection is made based on the first indication location, the touch sensor of the sensing unit located in a first region of the first sensing region corresponding to the contact surface of the thumb upon selection detects a contact of the thumb including a contact at the first indication location, and generates a first signal; when the selection is made based on the second indication location, the touch sensor of the sensing unit located in a second region of the second sensing region corresponding to the contact surface of the thumb upon selection detects a contact of the thumb including a contact at the second indication location, and generates a second signal; and when the selection is made based on a location between the first indication location and the second indication location, the touch sensors of the sensing unit located in the first region and the second region which have come into contact with the thumb together upon selection detect a contact of the thumb including contacts at the first indication location and the second indication location and generate different signals, and the different signals are set as a single new signal different from the first signal or the second signal; and data execution assigned to the first signal, the second signal or the single new signal generated by the selection is independently or successively performed.

Furthermore, in the touch input module according to the present invention, based on a single selection operation performed by a single thumb in the touch input module: in the generation of the first signal by the selection, the second indication location is spaced apart from the first indication location at a specific interval outside the contact surface of the thumb which has come into contact with the first region including the first indication location located at a center of the first sensing region; and, in the generation of the second signal by the selection, the first indication location is spaced apart from the second indication location at a specific interval outside the contact surface of the thumb which has come into contact with the second region including the second indication location located at a center of the second sensing region.

Furthermore, in the touch input module according to the present invention, based on a single selection operation performed by a single thumb in the touch input module, in the generation of the new single signal by the selection, the first indication location located at the center of the first detection region and the seconded location located at the center of the second detection region are located together within a region which comes into contact with the thumb upon selection.

Furthermore, in the touch input module according to the present invention, the first sensing region and the second sensing region are provided to correspond to the contact surface of the finger upon selection individually or collectively.

Furthermore, in the touch input module according to the present invention, based on a single selection operation by a single thumb in the touch input module, when the first sensing region and the second sensing region are selected together by the thumb: in the selection, when the first indication location has been included in a region with which the thumb has come into contact and the second indication location has been excluded from the region, the touch sensors of the sensing unit located in the first region and the second region are provided to detect the contact and generate different signals, and a specific control unit is provided to process only the first signal of the different signals, corresponding to a signal generated by the touch sensor of the sensing unit located in the first region including the first indication location, as a valid signal based on predetermined setting values of a plurality of signals; or in the selection, when the second indication location has been included in a region with which the thumb has come into contact and the first indication location has been excluded from the region, the touch sensors of the sensing unit located in the second region and the first region are provided to detect the contacts and generate different signals, and the control unit is provided to process only the second signal of the different signals, corresponding to a signal generated by the touch sensor of the sensing unit located in the second region including the second indication location, as a valid signal based on the setting values of a plurality of signals.

Furthermore, in the touch input module according to the present invention, at least one of a one side portion of the touch input module including the first sensing region and a remaining side portion of the touch input module including the second sensing region is formed to be depressed to a specific depth in a depth direction below the surface of the selection unit.

Furthermore, the sensing unit according to the present invention includes at least one of a touch pad and a touch screen.

Furthermore, in the touch input module according to the present invention, at least one of the one and remaining sides of the selection unit and at least one predetermined location between the one and remaining sides includes at least one of a protrusion, a groove and, a concave-convex part.

Furthermore, in the touch input module according to the present invention, in a signal generated by the selection in the touch input module: in a plurality of first signals, a plurality of second signals or a plurality of third signals successively generated from the first signal, the second signal or a third signal which is the single new signal based on a difference in a number of selections of the one side of the selection unit, the remaining side of the selection unit or a location between the one and remaining sides a single thumb: when a time interval of each of the first signals, the second signals and the third signals is within a reference value of a specific signal generation time lag based on the reference value, a specific control unit processes the first signals, the second signals and the third signals as a single new first signal, a single new second signal, and a single new third signal, respectively, which are different from the first signal, the second signal, and the third signal; and, when the time interval of each of the first signals, the second signals and the third signals exceeds the reference value, the control unit processes the first signals, the second signals and the third signals as a plurality of first signals, a plurality of second signals, and a plurality of third signals independently successively generated from the first signal, the second signal, and the third signal, respectively.

Furthermore, the touch input module according to the present invention includes a plurality of touch input modules, and the touch input modules are spaced apart from each other at a specific interval in at least one direction.

Furthermore, the touch input module according to the present invention includes a first touch input module and a second touch input module spaced apart from each other at a specific interval in a longitudinal direction; a single reference line is located in a lateral direction between the first touch input module and the second touch input module; and, based on a single selection operation performed by a single thumb, when the selection is made based on the reference line located between the first indication location of the first touch input module and the first indication location of the second touch input module: the first region of the first touch input module and the first region of the second touch input module spaced apart from each other at a specific interval come into contact with the thumb together upon selection; the touch sensors of the sensing unit located in the first region of the first touch input module and the first region of the second touch input module detect the contacts and generate different signals; and a specific control unit processes the different signals as a single new signal, different from the first signal generated from the first touch input module or the first signal generated from the second touch input module, based on predetermined setting values of a plurality of signals.

Furthermore, in the touch input module according to the present invention, based on a single selection operation performed by a single thumb, when the selection is made based on the reference line located between the second indication location of the first touch input module and the second indication location of the second touch input module: the second region of the first touch input module and the second region of the second touch input module spaced apart from each other at a specific interval come into contact with the thumb together upon selection; the touch sensors of the sensing unit located in the second region of the first touch input module and the second region of the second touch input module detect the contacts and generate different signals; and the control unit processes the different signals as a single new signal, different from the second signal generated from the first touch input module or the second signal generated from the second touch input module, based on the setting values of a plurality of signals.

Furthermore, in the touch input module according to the present invention, based on a single selection operation by a single thumb, when the selection is made based on the reference line located between one location between the first indication location and second indication location of the first touch input module and one location between the first indication location and second indication location of the second touch input module: the first region and second region of the first touch input module and the first region and second region of the second touch input module spaced apart from each other at a specific interval come into contact with the finger together upon selection; the touch sensors of the sensing unit located in the first region and second region of the first touch input module and the first region and second region of the second touch input module detect the contacts and generate different signals; and the control unit processes the different signals as a single new signal, different from the first signal and the second signal generated from the first touch input module or the first signal and the second signal generated from the second touch input module, based on the setting values of a plurality of signals.

Furthermore, the touch input module according to the present invention the touch input module includes a first touch input module and a second touch input module spaced apart from each other at a specific interval in a lateral direction; a single reference line is located in a longitudinal direction between the first touch input module and the second touch input module; and, based on a single selection operation by a single thumb, when the selection is made based on the reference line located between the first indication location of the first touch input module and the first indication location of the second touch input module: the first region of the first touch input module and the first region of the second touch input module spaced apart from each other at a specific interval come into contact with the thumb together upon selection; the touch sensors of the sensing unit located in the first region of the first touch input module and the first region of the second touch input module detect the contacts and generate different signals; and a specific control unit processes the different signals as a single new signal, different from the first signal generated from the first touch input module or the first signal generated from the second touch input module, based on predetermined setting values of a plurality of signals.

According to a second aspect of the present invention, there is presented a touch execution device using a thumb, which is provided such that a selection by a selection means including a finger is performed in a selection unit and data execution assigned to a signal generated by detection of a contact upon selection is performed, the touch execution device including: at least one touch input module including a selection unit configured to enable the selection to be performed by a single finger and a sensing unit provided to generate the signal in response to the selection; wherein, in the touch input module: the selection unit is provided in a specific size within a range corresponding to a fingerprint of the single thumb; the sensing unit includes a sensing region provided to generate a specific signal through detection of a contact of the finger upon selection, and the sensing region includes a first sensing region and a second sensing region formed to have regions each having a specific width and length on one and remaining sides of the touch input module, respectively, and located to face each other, based on a single thumb located at a central portion of the selection unit in the touch input module, a first indication location which is a reference location of the first sensing region and a second indication location which is a reference location of the second sensing region are located within a range in which the first indication location and the second indication location come into contact with a fingerprint of the thumb together, and the first indication location and the second indication location are respectively recognized as a selection location on one side of the selection unit and a selection location on an other side of the selection unit which are spaced apart from each other at a specific interval on one axis in one direction which passes through the first sensing region and the second sensing region and, simultaneously, are recognized as an interval selection location corresponding to a selection of a location between the one and remaining sides by the thumb; at least one central sensing region having a region of a specific size is further formed between the first sensing region and the second sensing region, and the central sensing region is spaced apart from the first sensing region and the second sensing region at a specific interval; based on a single selection operation by a single thumb in the touch input module: when the selection is made based on the first indication location, the touch sensor of the sensing unit located in a first region of the first sensing region corresponding to the contact surface of the thumb upon selection detects a contact of the thumb including a contact at the first indication location, and generates a first signal; when the selection is made based on the second indication location, the touch sensor of the sensing unit located in a second region of the second sensing region corresponding to the contact surface of the thumb upon selection detects a contact of the thumb including a contact at the second indication location, and generates a second signal; and, when the selection is made based on a location between the first indication location and the second indication location; the touch sensors of the sensing unit located in the first region and the second region which have come into contact with the thumb together and in a central region which is a region corresponding to the contact surface of the thumb which has come into contact with the central sensing region upon selection detect a contact of the thumb including the contacts at the first indication location and the second indication location and generate different signals, and the different signals are set as a single new signal different from the first signal, the second signal or a central signal generated by the contact of the central region; and data execution assigned to the first signal, the second signal or the single new signal generated by the selection is independently or successively performed.

Furthermore, in the touch input module according to the present invention, when the first sensing region and the central sensing region, the second sensing region and the central sensing region, or the first sensing region, the second sensing region and the central sensing region come into contact with the thumb together and two or more different signals are generated by a single selection by a single thumb in the touch input module: a specific control unit: processes only the first signal of the first signal and the central signal, which have been generated by the touch sensors of the sensing unit located in the first region and the central region, other than the first indication location, through sensing of the contacts, as a valid signal; processes only the second signal of the second signal and the central signal, which have been generated by the touch sensors of the sensing unit located in the second region and the central region, other than the second indication location, through sensing of the contacts, as a valid signal; or processes the first signal, the second signal and the central signal, which have been generated by the touch sensors of the sensing unit located in the first region other than the first indication location, the second region other than the second indication location, and the central region through sensing of the contacts, as a single new signal different from the first signal, second signal or central signal.

Furthermore, the touch input module according to the present invention the touch input module includes at least one of a plane portion, a concave portion, and a convex portion.

Furthermore, in the touch input module according to the present invention, an assisting means adapted to assist the identification of a selection location where the selection is made is provided in the touch input module, and the assisting means includes at least one of a protrusion, a groove, a line, a shape, a color, shade, a sound, and light.

Furthermore, in the touch input modules according to the present invention, a connection frame configured to connect one touch input module and another touch input module spaced apart from each other at a specific interval in at least one direction is provided in the touch input modules, and the connection frame has at least one of a band shape, a detachable shape, and a deformable shape.

Furthermore, the touch input module according to the present invention is provided at a specific location of an electronic device to which the touch execution device is applied, the selection unit of the touch input module is provided to be displayed on a display portion or an indication portion, or the display portion or the indication portion is formed in at least one of the touch input module, the touch execution device, and the electronic device.

Furthermore, the touch input module according to the present invention is included in an interface unit having a specific shape, the selection is made in the interface unit, and the signal is generated by the selection, and the interface unit and the touch execution device are provided to be detachable from each other.

Furthermore, a detachable means configured to enable the interface unit and the touch execution device to be attached or detached to and from each other according to the present invention includes a detachable member, and the detachable member includes one or more of a protrusion, a groove, a slot, a guide, a latch, a holder, a ring, a band, Velcro, and a member having a repetitive feedback property.

Furthermore, a terminal is provided at one or more specific locations of the interface unit and the touch execution device according to the present invention, and the terminal transfers a signal generated from the interface unit or the touch execution device, or transfers a transfer signal of data assigned to the signal.

Furthermore, the selection unit according to the present invention is provided in the form of a plurality of selection units, and the selection units are spaced apart from each other at a specific interval in at least one direction.

### ADVANTAGEOUS EFFECTS

The touch execution device of the present invention includes at least one touch input module having the selection unit which enables a selection by a selection means to be performed within a region corresponding to the fingerprint of a single thumb, and two different sensing regions (the first sensing region and the second sensing region) in the touch input module are provided on one axis in one direction that passes through the sensing regions so that they correspond to the contact surface of the finger upon selection respectively or collectively. Accordingly, the two sensing regions in each of which a specific signal is generated in response to a selection made in the selection unit are characterized in that they are recognized as three different selection locations (the selection location on one side of the selection unit, the selection location on the other side of the selection unit, and a selection correspondence location between the one and other sides) on the contact surface of the single thumb at and around the center of the sensing regions. Accordingly, in the touch input module, in the selection, based on a single selection operation performed by a single thumb, three different types of data input are performed by three selection operations performed on the respective sensing regions. Accordingly, an advantage arises in that data execution in which one or more of data input and data control are independently or successively, easily and rapidly performed through an intuitive selection of a selection location, recognized upon selection, by a single finger.

Furthermore, different sensing regions are located on the one and other sides of the touch input module of the present invention in a form in which they are spaced apart from each other at a specific interval and face each other, and the reference locations of the respective different sensing regions are located within a range in which they come into contact with the fingerprint of a single thumb based on the fingerprint. Accordingly, advantages arise in that the frequency of the erroneous manipulations of a finger can be decreased, or the accumulation of fatigue on the finger or the generation of stress can be suppressed in independent or continuous selection operations that are repeatedly performed two or more times.

Furthermore, an advantage arises in that a user can select each of the reference locations of the touch input module or one or more of specific sensing regions including the reference locations naturally without separate learning through a familiar selection operation of a single finger even in the state of carrying, gripping or wearing the device of the present invention, in the state of being moved, or in the state of moving.

Furthermore, the present invention has an advantage in that the touch input module or the touch execution device provides the opportunity of configuring further various devices to a user or provides a more improved user environment for data execution to a user because it can be easily applied to various types of electronic devices including a wearable device, a variable device, an IoT device, a composite device and can be easily configured in the form of a detachable or portable accessory in the electronic devices.

### BRIEF DESCRIPTION OF DRAWINGS

FIG. 1 is a diagram showing the schematic configuration of an embodiment of a touch execution device according to the present invention;

FIG. 2 is an exemplary diagram illustrating the performance of data execution according to an embodiment of the touch execution device of the present invention;

FIG. 3 (a)-(d) is an exemplary diagram illustrating the schematic configuration of the touch execution device according to an embodiment of the present invention;

FIG. 4 (a)-(e) is an exemplary diagram illustrating the configuration of a touch input module according to an embodiment of the present invention, a selection made in the touch input module, and the generation or processing of a signal by the selection;

FIG. 5 (a)-(e) is an exemplary diagram illustrating the configuration of a touch input module according to an embodiment of the present invention, which is different from that of FIG. 4, a selection made in the touch input module, and the generation or processing of a signal by the selection;

FIG. 6 (a)-(b) is an exemplary diagram illustrating the configurations of a plurality of touch input modules and a connection frame according to an embodiment of the present invention;

FIGS. 7 (a)-(j) and 8 (a)-(g) are exemplary diagrams of various configurations of the touch input module according to embodiments of the present invention;

FIG. 9 (a)-(f) is an exemplary diagram illustrating various configurations of a sensing region according to embodiments of the present invention;

FIGS. 10 (a)-(d) and 11 (a)-(f) are exemplary diagrams illustrating the configurations of a plurality of the touch input modules according to embodiments of the present invention, a selection made in the touch input modules, and the generation or processing of a signal by the selection;

FIG. 12 (a)-(d) is an exemplary diagram illustrating various configurations of touch input modules provided in a plural number according to embodiments of the present invention;

FIGS. 13 (a)-(e) and 14 (a)-(e) are exemplary diagrams illustrating a signal generated by a sensing unit according to an embodiment of the present invention;

FIG. 15 (a)-(g) is an exemplary diagram illustrating the configuration of data assigned to a signal generated by the sensing unit according to the present invention or various types of data execution performed by the signal processing;

FIGS. 16 (a)-(e) and 17 (a)-(c) are exemplary diagrams illustrating the configurations of a touch input module according to the ones of the embodiments of the present invention, which are different from that of FIG. 4 or 5, or a selection made in the touch input module;

FIG. 18 (a)-(f) is an exemplary diagram of various configurations of a sensing region according to the ones of the embodiments of the present invention, which are different from that of FIG. 9; and

FIGS. 19 (a)-(k) and 20 (a)-(e) are exemplary diagrams illustrating various configurations of the touch input module or touch execution device according to the present invention.

### DETAILED DESCRIPTION OF THE INVENTION

As a best mode for the practice of the invention, the present invention provides a touch execution device 1 using a thumb, which is provided such that a selection by a selection means including a finger is made in a selection unit and data execution assigned to a signal generated through the detection of a contact upon selection is performed, the touch execution device including:

at least one touch input module 60, including a selection unit 100 configured to enable the selection to be performed by a single finger and a sensing unit 200 provided to generate the signal in response to the selection;

wherein in the touch input module:

the selection unit is provided in a specific size within a range corresponding to the fingerprint of the single thumb;

the sensing unit includes a sensing region 210 provided to generate a specific signal through the detection of a contact of the finger upon selection, and the sensing region includes a first sensing region and a second sensing region formed to have regions each having a specific width and length on the one and other sides of the touch input module, respectively, and located to face each other;

based on a single thumb located at the central portion of the selection unit in the touch input module, a first indication location P1 which is the reference location of the first sensing region and a second indication location P2 which is the reference location of the second sensing region are located within a range in which the first indication location and the second indication location come into contact with the fingerprint of the thumb together, and the first indication location and the second indication location are respectively recognized as a selection location on one side of the selection unit and a selection location on the other side of the selection unit which are spaced apart from each other at a specific interval on one axis in one direction which passes through the first sensing region and the second sensing region and, simultaneously, are recognized as an interval selection location corresponding to a selection of a location between the one and other sides by the thumb;

based on a single selection operation performed by a single thumb in the touch input module:

when the selection is made based on the first indication location, the touch sensor of the sensing unit located in a first region of the first sensing region corresponding to the contact surface of the thumb upon selection detects a contact of the thumb including a contact at the first indication location, and generates a first signal;

when the selection is made based on the second indication location, the touch sensor of the sensing unit located in a second region of the second sensing region corresponding to the contact surface of the thumb upon selection detects a contact of the thumb including a contact at the second indication location, and generates a second signal; and

when the selection is made based on a location between the first indication location and the second indication location, the touch sensors of the sensing unit located in the first region and the second region which have come into contact with the thumb together upon selection detect a contact of the thumb including contacts at the first indication location and the second indication location and generate different signals, and the different signals are set as a single new signal different from the first signal or the second signal; and

data execution assigned to the first signal, the second signal or the single new signal by the selection is independently or successively performed.

Embodiments of a touch execution device according to the present invention will be described in detail below with reference to the accompanying drawings.

The meanings of terms used herein are described first.

In the present invention, a sensing region refers to a region of a specific size provided to generate a specific signal by detecting the contact of a selection means upon selection by the selection means.

In the present invention, a contact correspondence region or a region corresponding to a contact refers to a region of the sensing region that corresponds to the contact surface of the selection means upon selection by the selection means. The overall sensing region may correspond to the contact correspondence region and a portion of the sensing region may correspond to the contact correspondence region depending on the contact surface of the selection means upon selection. The contact correspondence region includes an indication location, i.e., the reference location of the sensing region.

In the present invention, a selection unit refers to a region which is formed such that a selection by the selection means is performed. The selection unit may be provided in a specific size including the overall sensing region or a specific size equal to or larger than the sensing region.

In the present invention, the term “selection,” “select(s),” or a “selection is made (or performed)” means that the “selection means is caused to be brought into contact with the sensing region” or the “selection means is brought into contact with the sensing region.”

In the present invention, the term “locate(s)” or be “be located” includes the meaning of “be present at a designated location” or “cause(s) (something) to be present at a designated location,” and may include the meaning “be formed at a designated location” or “cause(s) (something) to be formed at a designated location” depending on the configuration of the invention.

In the present invention, the selection means includes a finger, an assisting means, etc. . . . . The thumb of the fingers is suitable for the selection means. That is, in a selection by a finger made in the selection unit, although various selection operations or selection directions are taken into account according to the habit of the finger movement of a user, the selection may be easily implemented by a single thumb. The assisting means may include various touch means including a thimble type means which assists the movement of a finger.

In the present invention, the term “selection operation” refers to the “selection action of the selection means performed on indication location, i.e., the reference location of the sensing region, or the sensing region” or the “movement of the selection means performed on the indication location or the sensing region.” The selection operation includes at least one of touching, pressing, tapping, tilting, rolling, sliding, dragging, pushing, and pulling.

In the present invention, the data execution means that data assigned to a specific signal generated in response to a selection by a selection means in a touch input module is output to an electronic device and executed by signal processing based on the signal.

A signal according to the present invention includes an electrical signal based on an event. The event includes the above-described selection or selection operation. Furthermore, the signal or electrical signal may include an analog signal, a digital signal, a composite signal, etc. The signal or electrical signal may be transferred via a specific terminal. Alternatively, a transfer signal corresponding to the signal or electrical signal may be transferred via the terminal.

An electronic device according to the present invention collectively refers to all electric and electronic products that are fabricated to use or adaptively use electronic technology and apply it to actual life. The electronic device includes a computer device, a sound device, an image device, an information device, a communication device, an information communication device, a game device, a wired device, a wireless device, a wearable device, a video device, a variable device, an IoT device, a composite device, etc. Furthermore, the configuration of the electronic device may include various types of terminals, peripheral devices, devices, interface units, etc.

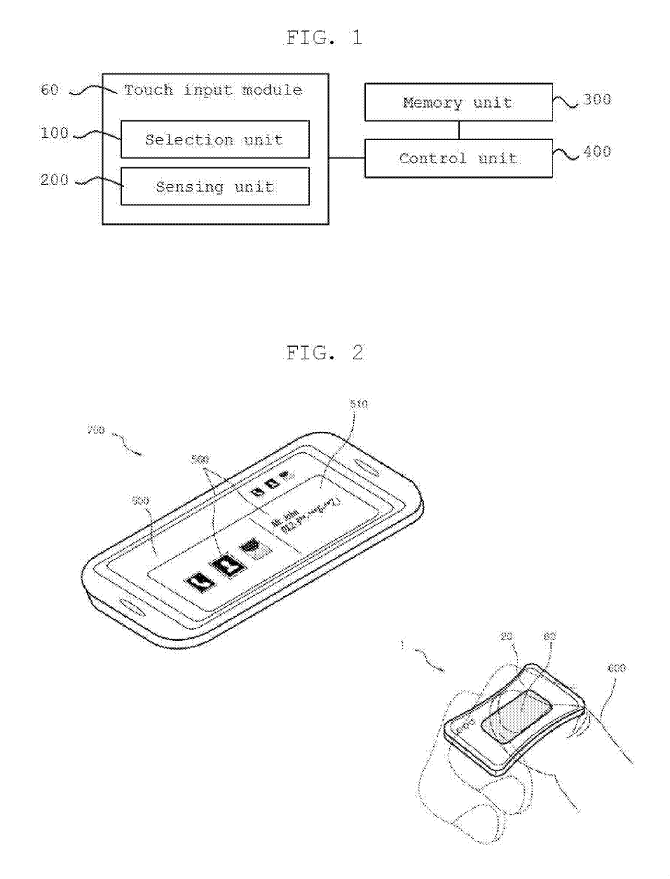

FIG. 1 is a diagram showing the schematic configuration of an embodiment of a touch execution device according to the present invention.

As shown in FIG. 1, the touch execution device is configured to include at least one touch input module 60, a memory unit 300, and a control unit 400.

The touch input module 60 is configured to include a selection unit 100 configured such that a selection by a selection means including a finger 600 is made therein, and a sensing unit 200 provided to generate a specific signal S in response to the selection.

The selection unit 100 refers to a region of a specific size which is formed on the touch input module on which a selection by a selection means is made. It is preferred that the selection unit may be provided in a specific size within a range corresponding to the fingerprint 610 of a single thumb 601. The selection unit may be provided in a single form with respect to a sensing region 210 formed in the sensing unit. Furthermore, the selection unit may be provided in the form of deformable hardware which can be deformed to a specific form or pattern, which can be recovered from the deformed shape or pattern to a state before the deformation, or which can repeat deformation and recovery. Alternatively, the selection unit may be provided in the form of non-deformable hardware, not the deformable hardware. Furthermore, the selection unit may be provided in the form of a display which is displayed on a specific display portion 500 or an indication portion 510. Furthermore, the selection unit may be configured to include one or more of glass, a film, synthetic resin, a composite member, a deformable member, and an elastic member having a repetitive feedback property.

The sensing unit 200 may be provided to include at least one of a touch pad and a touch screen. The sensing unit may be provided in various forms corresponding to the forms of the selection unit. The touch sensor of the sensing unit which detects the contact of a selection means and generates a specific signal may be formed in a pattern having a specific form. The pattern may be composed of a single pattern or a plurality of patterns. For example, the touch sensor may be entirely or partially formed in a pattern having a lattice form or a lozenge form. Furthermore, the touch sensor may be provided in various forms, including a film form, a glass form, a display-integrated form, a metal mesh form, a silver nanowire form, a carbon nanotube form, a graphene form, and a composite form. Furthermore, the touch sensor may include a sensor that detects one or more of the contact direction, contact strength and contact pressure of a selection means. The sensor may be of a resistive film type, a capacitive type, a surface acoustic wave type, an infrared type, an optical type, or a tactile pressure type.

The memory unit 300 stores data assigned to a specific signal. A specific execution command to enable data execution according to the present invention to be executed may be previously set in the signal. The data may be classified for each menu option based on a specific unit and stored in the memory unit. Alternatively, the data may be subdivided into several data sets and stored in the memory unit.

The data execution includes data input. The data input includes the meaning that “data is input in response to a selection by a selection means in the touch input module” or that “data is input in response to a selection by a selection means in the touch input module and displayed on a display portion or an indication portion. The objects of the data input include a character, a number, a symbol, a special character, a special symbol, etc. For example, the character refers to one of the characters that are being used in the countries of the world.

Furthermore, the data execution includes data control. The data control includes the meaning that “specific hardware or software is executed in response to a selection by a selection means in the touch input module” or that a “program operating in conjunction with specific hardware is executed in response to a selection by a selection means in the touch input module.” The objects of the data control include a keyboard function, a mouse function, an information communication function, a search function, a play function, a motion function, a setting function, etc. The keyboard function or mouse function includes Mode, Enter, Space, F (function), Esc, Back, Shift, Ctrl (control), Alt, Tab, Caps Lock, Home, Del, Page, Capture, Pointing, Click, Scroll, Drag, Call, Zoom, Direction, Speed, Change, Return, etc. For example, the objects of the pointing may include a display portion, a program, application software, etc. including an Internet page, a document, a menu window or a popup window. Furthermore, the objects of the information communication function include a telephone, contact information, a message, a note, a clock, the Internet, etc. Furthermore, the objects of the search function include Googling, a document, a file, a menu, content, etc. Furthermore, the objects of the play function include music, a moving image, voice, sound, a broadcast, a movie, a game, a character, a camera, an image, etc. Furthermore, the motion function includes a movement control function such as the control of start, moving forward, moving rearward, temporary stop, stop, lifting, lowering, tilting, bending, rotation, jump, return, zigzag movement, protrusion and depressing, motion control, remote control, etc., a direction control function, a variable direction control function, or a remote control function. Furthermore, the objects of the setting function include a user environment, an option, a symbol, reservation, etc. The objects of the data input and the objects of the data control are not limited to the components of the data based on the present invention.

The control unit 400 determines the signal of the sensing unit which is generated in response to a selection by a selection means made in the selection unit 100 of the touch input module, extracts data, which is assigned to the determined signal and which corresponds to the data input or the data control, from the memory unit, and processes the extracted data.

This is described below in detail via various embodiments.

FIG. 2 is an exemplary diagram illustrating the performance of data execution according to an embodiment of the touch execution device of the present invention.

As shown in FIG. 2, the touch execution device may be configured to be connected to an electronic device 700 equipped with a display portion 500 or an indication portion 510.

FIG. 2 shows an embodiment in which a user places a single finger 600 on a touch input module 60 provided in the touch execution device and performs data execution by the selection of the finger which is performed on different sensing regions, including a first indication location and a second indication location spaced apart from each other at a specific interval, in the selection unit 100 of the touch input module.

That is, referring to FIG. 2, a user may independently or successively select an object 560 displayed on the display portion 500 or indication portion 510 of the electronic device 700 or the object 560 displayed on a specific indication portion 510 by using the touch execution device 1 including at least one touch input module 60.

Accordingly, a user may independently or successively, easily and rapidly perform data execution in which one or more of data input and data control are performed in response to a selection by the single finger 600 which is performed on one or more indication locations or sensing regions in the touch execution device 1.

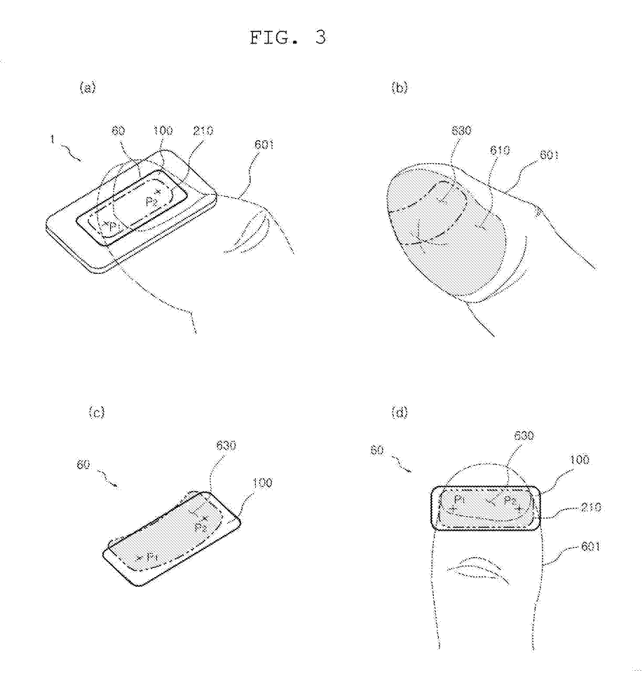

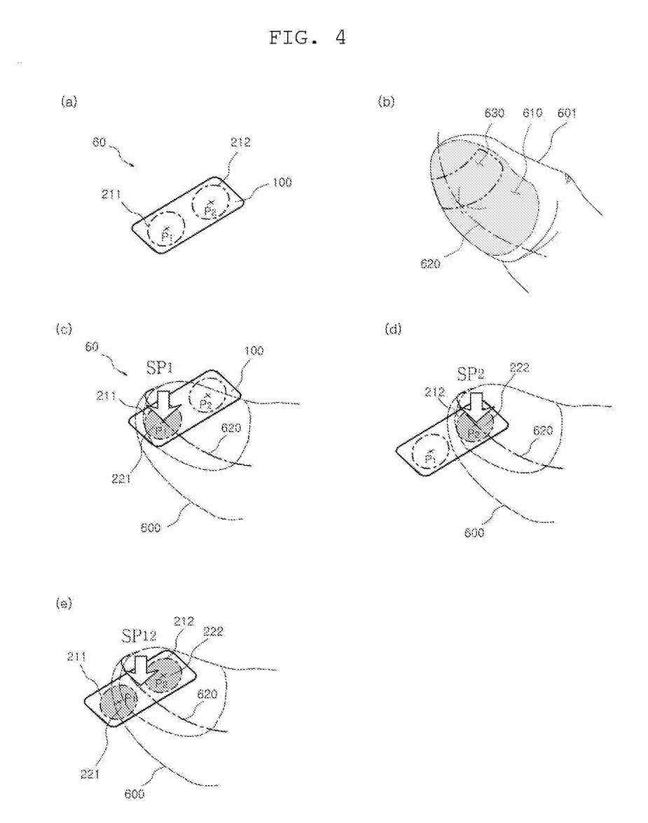

FIG. 3 is an exemplary diagram illustrating the schematic configuration of the touch execution device 1 according to an embodiment of the present invention.

Referring to FIG. 3(a), the touch input module 60 includes a selection unit 100 and a sensing unit 200.

In this case, as shown in FIG. 3(a), the sensing unit 200 includes a sensing region 210 of a specific size which generates a specific signal by detecting the contact of a single finger 600 upon selection by the finger.

Furthermore, as shown in FIGS. 3(a) and 3(d), P1, i.e., the reference location of one side of the touch input module, is located in the sensing region located on one side of the touch input module. P2, i.e., the reference location of the other side of the touch input module, is placed in the sensing region located on the other side of the touch input module.

In this case, referring to FIGS. 3, P1 and P2 placed on the one and other sides of the touch input module 60, respectively, are located in a form in which they face each other at locations spaced apart from each other at a specific interval within a range corresponding to the fingerprint 610 of the single thumb 601. However, the form of the facing does not limit the configurations of P1 and P2.

Furthermore, as shown in FIGS. 3(a) and 3(d), in the touch input module, P1 and P2 are located within a region with which the fingerprint 610 of the single thumb 601 located at and around the center of the selection unit 100 comes into contact.

That is, in the touch input module, P1 and P2 are characterized in that they are recognized as a selection location on one side of the selection unit and a selection location on the other side of the selection unit, respectively, which are spaced apart from each other at a specific interval on one axis in one direction within the selection unit and, simultaneously, are recognized as an interval selection location corresponding to a selection by the single thumb 601 for a location between the one and other sides.

Accordingly, a selection by a selection means made in the touch input module may be made as an intuitive selection by the single finger 600 for the substantially one or more selection locations (P1, P2, and/or the location between P1 and P2).

That is, in the touch input module 60 of the present invention configured as described above, data execution in which one or more of data input and data control are performed in response to an intuitive selection by the single finger 600 for one side of the selection unit corresponding to the selection location, the other side of the selection unit corresponding to the selection location and the location between the one and other sides may be independently or successively, easily and rapidly performed.

Referring to FIGS. 3(b) and 3(c), a range corresponding to the fingerprint 610 of a single thumb 601 is the indication region of the overall fingerprint.

That is, the indication region of the overall fingerprint may be displayed as a region that appears through a contact between the fingerprint 610 and a specific reference surface when the fingerprint 610 in the end portion of the thumb is brought into close contact with the specific reference surface and put through a rolling movement from the end of one side of the fingerprint to the end of the other side of the fingerprint.

In this case, as shown in FIGS. 3(b) and 3(c), in the touch input module 60, when the single thumb 601 is located in the selection unit 100, a selection correspondence region 630 which belongs to a region of the selection unit with which the fingerprint 610 of the finger comes into contact and which corresponds to a corresponding region of the sensing region 210 which detects the contact and generates a specific signal may be formed in the selection unit.

FIG. 4 is an exemplary diagram illustrating the configuration of the touch input module 60 according to an embodiment of the present invention, a selection made in the touch input module, and the generation or processing of a signal by the selection.

Referring to FIG. 4, the sensing region 210 provided in the sensing unit 200 of the touch input module may include a first sensing region 211 of a specific size and a second sensing region 212 of a specific size which may correspond to the contact surface of the single finger 600. It is preferred that the first sensing region and the second sensing region are configured to be located to face each other on the one and other sides of the touch input module. Furthermore, the first sensing region and the second sensing region are formed as respective regions, each having a specific width and length, on the one and other sides of the touch input module, and are provided to correspond to the respective contact surfaces of the finger upon selection or to correspond to the contact surface of the finger together upon selection. That is, in the touch input module 60, the first sensing region 211 is a region of a specific size including the first indication location P1 located on one side of the touch input module. The second sensing region 212 is a region of a specific size including the second indication location P2 located on the other side of the touch input module. It is preferred that the selection is made such that the indication location is located at and around the center of the contact surface of a selection means upon selection. The indication location may be located out of the center of the contact surface depending on the location or form of the contact surface of the selection means upon selection.

As shown in FIG. 4, the first indication location P1, i.e., the reference location of the first sensing region 211, and the second indication location P2, i.e., the reference location of the second sensing region 212, are located within a range in which both the first indication location P1 and the second indication location P2 come into contact with the fingerprint 610 of the single thumb 601 based on the thumb 601 located in the central portion of the selection unit 100 in the touch input module.

According to the characteristic of the configuration of the touch input module 60, in the touch input module, the first indication location P1 and the second indication location P2 may be recognized as a selection location on one side of the selection unit and a selection location on the other side of the selection unit, respectively, which are spaced apart from each other at a specific interval on one axis in one direction within the selection unit, and, simultaneously, may be recognized as an interval selection location corresponding to a selection by the single thumb 601 for the location between the one and other sides. That is, according to the characteristic, a user may substantially perform input through an intuitive selection by the single finger 600 for the recognized three selection locations (the one side of the selection unit, the other side of the selection unit and the location between on the one and other sides) by a selection by the selection means in the touch input module.

As an example, as shown in FIG. 4(c), based on a single selection operation by the single thumb 601 in the touch input module, when the selection is made at and around the first indication location P1, i.e., a selection location on one side of the selection unit (SP1), the touch sensor of the sensing unit 200 located in the first region 221 of the first sensing region 211 corresponding to the contact surface of the thumb upon selection detects the contact of the thumb including a contact at the first indication location, and generates a first signal S1.

In this case, the control unit 400 determines the signal based on the selection, extracts data, assigned to the determined signal S1, from the memory unit 300, and output the extracted data or the electrical signal of the extracted data to the electronic device 700 so that data execution in which one or more of data input and data control set in the data or the electrical signal of the data are performed is independently or successively performed.

In this case, referring to FIG. 4(c), in the generation of the first signal S1 by the selection, the second indication location P2 is spaced apart from the first indication location P1 located at the center of the first sensing region 211 at a specific interval, and is located outside the contact surface of the thumb that comes into contact with the first region 221 including the first indication location P1.

Referring to FIGS. 4(b) and 4(c), in the selection, it may be preferred that the fingerprint center line 620 of the finger that longitudinally passes through the center of the fingerprint 610 of the finger is located at the first indication location P1 or is located in proximity to the first indication location P1.

As shown in FIG. 4(c), the overall first sensing region 211 may correspond to the first region 221 based on the contact surface of the finger upon selection.

Alternatively, the first indication location P1 may be located outside the first region depending on the location or form of the contact surface of the finger upon selection.

In the selection, the control unit enables data execution, corresponding to data input in which the data assigned to the first signal S1 is input or data control in which the data assigned to the first signal is controlled, to be performed through the signal processing of the first signal.

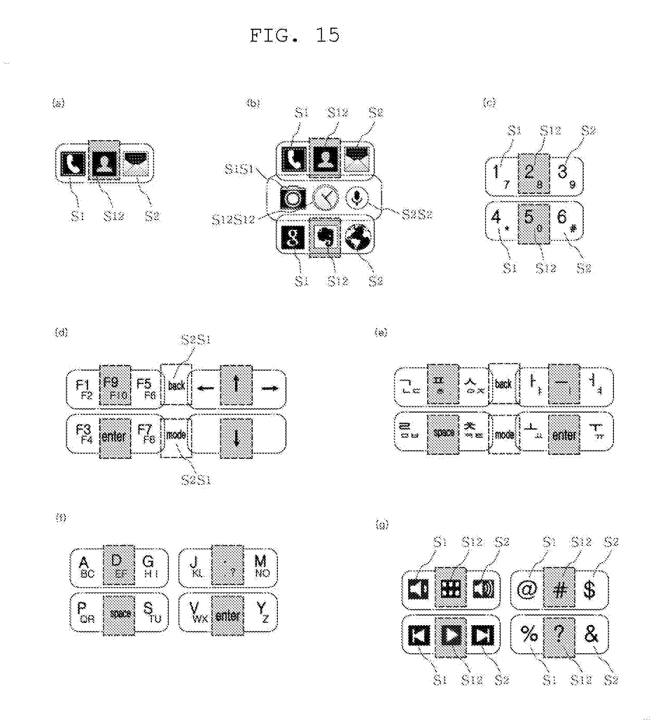

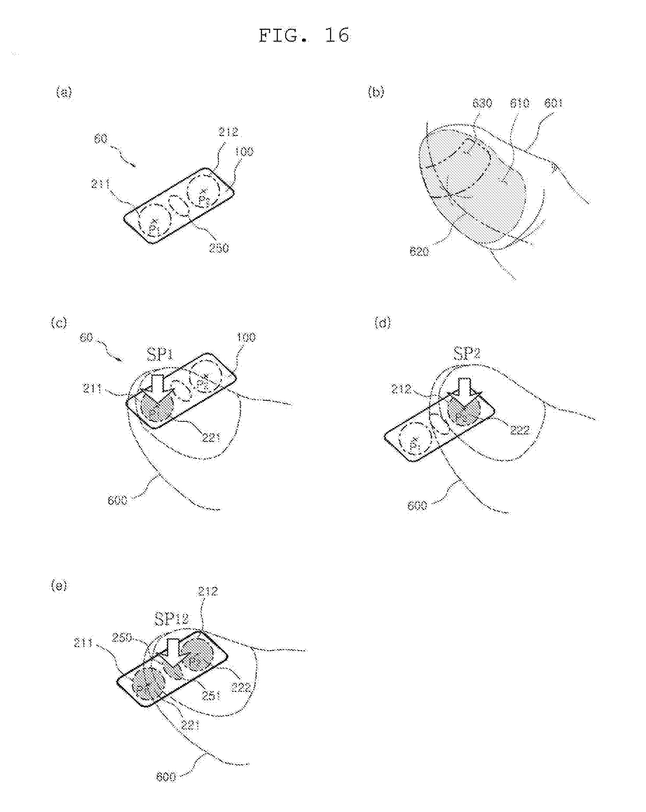

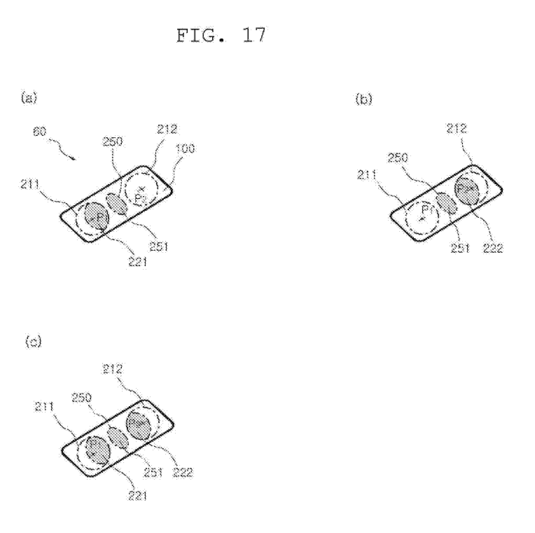

For example, referring to FIGS. 13(a) and 15(a), the data assigned to the first signal S1 is a “telephone,” i.e., the information communication function among the objects of the data control. That is, the control unit outputs the telephone data of the information communication function, which has been generated and determined by the selection and that corresponds to the first signal S1 or the electrical signal of the telephone data, to the electronic device 700 so that data execution regarding the “telephone” is performed. In this case, the telephone data may include various functions, such as call listing, which are executed via a specific display portion 500 or indication portion 510.

As another example, as shown in FIG. 4(d), based on a single selection operation by the single thumb 601 in the touch input module, when the selection is made based on the second indication location P2, i.e., a selection location on the other side of the selection unit (SP2), the touch sensor of the sensing unit 200 located in the second region 222 of the second sensing region 212 corresponding to the contact surface of the thumb upon selection detects the contact of the thumb including a contact at the second indication location, and generates a second signal S2.

In this case, the control unit 400 determines a signal based on the selection, extracts data assigned to the determined signal S2 from the memory unit 300, and outputs the extracted data or the electrical signal of the extracted data to the electronic device 700 so that data execution in which one or more of data input and data control set in the data or the electrical signal of the data are performed is independently or successively performed.

In this case, referring to FIG. 4(d), in the generation of the second signal S2 by the selection, the first indication location P1 is spaced apart from the second indication location P2 located at the center of the second sensing region 212 at a specific interval, and is located outside the contact surface of the thumb that comes into contact with the second region 222 including the second indication location P2.

Referring to FIGS. 4(b) and 4(d), in the selection, it may be preferred that the fingerprint center line 620 of the finger that longitudinally passes through the center of the fingerprint 610 of the finger is located at the second indication location P2 or is located in proximity to the second indication location P2.

As shown in FIG. 4(d), the overall second sensing region 212 may correspond to the second region 222 based on the contact surface of the finger upon selection.

Alternatively, the second indication location P2 may be located outside the second region depending on the location or form of the contact surface of the finger upon selection.

In the selection, the control unit enables data execution, corresponding to data input in which the data assigned to the second signal is input or data control in which the data assigned to the second signal is controlled, to be performed through the signal processing of the second signal S2.

For example, referring to FIGS. 13(a) and 15(a), the data assigned to the second signal S2 is a “message,” i.e., the information communication function among the objects of the data control. That is, the control unit outputs the message data of the information communication function, which has generated and determined by the selection and which corresponds to the second signal S2 or the electrical signal of the message data, to the electronic device 700 so that data execution regarding the “message” is performed. In this case, the message data may include various functions, such as a social network service (SNS), which are executed via the specific display portion 500 or indication portion 510.

According to the characteristics of the configuration of the touch input module 60 of the present invention described in the embodiments of FIGS. 4(c) and 4(d), a selection by a selection means made in the selection unit 100 of the touch input module may be naturally executed in response to an intuitive selection by the single finger 600 between the first indication location P1 and the second indication location P2, i.e., a selection location between the one and other sides of the selection unit.

As an example, as shown in FIG. 4(e), based on a single selection operation by the single thumb 601 in the touch input module, when the selection is made based on the location between the first indication location P1 and the second indication location P2, i.e., a selection location between the one and other sides of the selection unit (SP12), the touch sensors of the sensing unit located in the first region 221 and the second region 222 that have come into contact with the thumb together upon selection detect the contact of the thumb including contacts at the first indication location P1 and the second indication location P2, and generate different signals. The different signals may be set as a single new signal different from the first signal or the second signal. That is, the single new signal may be previously set as S12 different from the signal S1 or the signal S2 based on the predetermined setting values of a plurality of signals.

In this case, the control unit 400 determines a signal based on the selection, extracts data assigned to the determined signal S12 from the memory unit 300, and outputs the extracted data or the electrical signal of the extracted data to the electronic device 700 so that data execution in which one or more of data input and data control set in the data or the electrical signal of the data are performed is independently or successively performed.

In this case, referring to FIG. 4(e), in the generation of the single new signal S12 based on the selection, the first indication location P1 located at the center of the first sensing region 211 and the second indication location P2 located at the center of the second sensing region 212 are located together within a region that comes into contact with the thumb upon selection.

Furthermore, referring to FIGS. 4(b) and 4(e), in the selection, it may be preferred that the fingerprint center line 620 of the finger that longitudinally passes through the center of the fingerprint 610 of the finger is located at the center between the first indication location P1 and the second indication location P2 or is located in proximity to the center.

If a selection by the single finger 600 is made in the selection unit 100 of the touch input module as shown in FIG. 4(e), the first sensing region 211 and second sensing region 212 of the touch input module may correspond to the first region 221 and the second region 222 based on the contact surface of the finger upon selection.

In the selection, the control unit enables data execution, corresponding to data input in which the data assigned to the signal S12 is input or data control in which the data assigned to the signal S12 is controlled, to be performed through the signal processing of the single new signal S12.

For example, referring to FIGS. 13(b) and 15(a), the data assigned to the single new signal S12 is the “contact information” of the information communication function among the objects of the data control. That is, the control unit outputs the contact information data of the information communication function that has been generated and determined by the selection and that corresponds to the signal S12 or the electrical signal of the contact information data to the electronic device 700 so that data execution regarding the “contact information” is performed. In this case, the contact information data may include various functions, such as keyword listing, which are executed via a specific display portion 500 or indication portion 510.

As described in the embodiments of FIGS. 4(c), 4(d) and 4(e), the touch input module 60 is characterized in that it enables three different data executions to be performed in the selections SP1, SP2, and SP12 which belong to selections by a selection means in the selection unit 100 of the touch input module and each of which is performed on the indication locations P1 and P2 once based on one indication location P1 located on one side of the touch input module and the other indication location P2 located on the other side of the touch input module within the region with which the fingerprint 610 of the single thumb 601 comes into contact, and in that it enables data execution in which one or more of data input and data control are performed on the data assigned to the first signal, the second signal or the single new signal based on the selection to be independently or successively made.

The touch input module may be provided in a hardware form, such as a key, a button or a switch.

A selection by a selection means made in the selection unit 100 of the touch input module 60 of the present invention may be implemented in a form different from the above-described embodiments of FIGS. 4(c) to 4(e) according to the characteristics of the configuration of the touch input module.

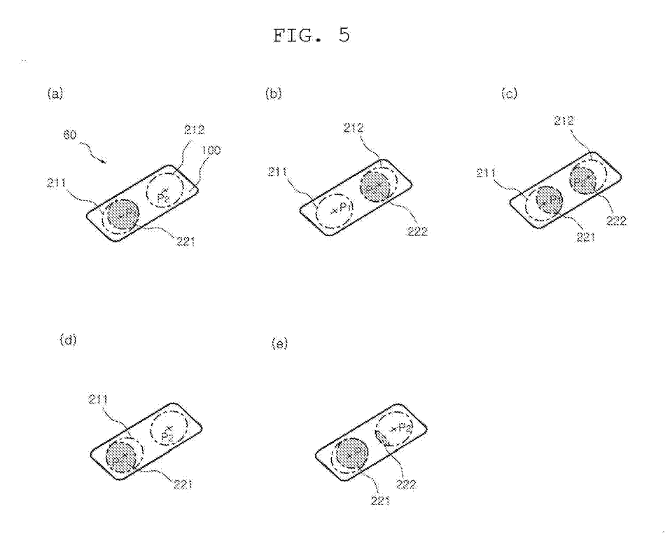

As an example, as shown in FIG. 5(a) or 5(d), based on a single selection operation by the single thumb 601 in the touch input module, in the selection, a portion of the first sensing region 211 of the touch input module is selected by the finger. The touch sensor of the sensing unit 200 located in the first region 221 of the first sensing region corresponding to the contact surface of the finger detects the contact of the finger by the selection, and generates the first signal S1.

In this case, referring to FIG. 5(a) or 5(d), a portion of the first sensing region 211 may correspond to the first region 221 based on the contact surface of the finger upon selection.

In the selection, the first indication location P1 of the touch input module may be included in or excluded from a region with which the finger comes into contact depending on the contact surface of the finger upon selection.

Alternatively, as shown in FIG. 5(e), based on a single selection operation by the single thumb 601 in the touch input module, in the selection, portions of the first sensing region 211 and second sensing region 212 of the touch input module may be selected together by the finger, and the first region 221 of the first sensing region and the second region 222 of the second sensing region that belong to the sensing region may come into contact with the finger together by the selection.

That is, in the state in which the first indication location P1 of the first sensing region has been included in the region with which the finger comes into contact upon selection and the second indication location P2 of the second sensing region has been excluded from the region, the touch sensors of the sensing unit located in the first region 221 of the first sensing region and the second region 222 of the second sensing region detect the contacts, and generate different signals.

In this case, a specific control unit 400 may be configured to process only the first signal S1, corresponding to a signal which belongs to the different signals and which has been generated by the touch sensor of the sensing unit located in the first region 221 including the first indication location P1, as a valid signal based the predetermined setting values of a plurality of signals.

As another example, as shown in FIG. 5(b), based on a single selection operation by the single thumb 601 in the touch input module, in the selection, a portion of the second sensing region 212 of the touch input module is selected by the finger. The touch sensor of the sensing unit 200 located in the second region 222 of the second sensing region corresponding to the contact surface of the finger detects the contact of the finger by the selection, and generates the second signal S2.

In this case, referring to FIG. 5(b), a portion of the second sensing region 212 may correspond to the second region 222 based on the contact surface of the finger upon selection.

Alternatively, as shown in FIG. 5(c), based on a single selection operation by the single thumb 601 in the touch input module, in the selection, the second sensing region 212 of the touch input module and a portion of the first sensing region 211 may be selected by the finger together, and the second region 222 of the second sensing region and the first region 221 of the first sensing region that belong to the sensing region may come into contact with the finger together by the selection.

That is, in the state in which the second indication location P2 of the second sensing region has been included in the region with which the finger comes into contact upon selection and the first indication location P1 of the first sensing region has been excluded from the region, the touch sensors of the sensing unit located in the second region 222 of the second sensing region and the first region 221 of the first sensing region detect the contacts, and generate different signals.

In this case, the specific control unit 400 may be configured to process only the second signal S2, corresponding to a signal of the different signals generated by the touch sensor of the sensing unit located in the second region 222 including the second indication location P2, as a valid signal based on the predetermined setting values of a plurality of signals.

The setting values of the plurality of signals may be previously set such that only the signal S1 or S2 generated from the region 221 or 222 including a specific indication location P1 or P2 is processed as a valid signal if the different signals S1 and S2 are generated from the different regions 221 and 222 within the reference value of a signal generation time lag. The reference value of the signal generation time lag may be set to 0.1 seconds, and may be determined by applying the reference value of a signal generation time lag for a plurality of common signals. The setting values of a plurality of signals or the reference value of the signal generation time lag may be applied to the following embodiments corresponding to the above descriptions in the same manner. The setting values of a plurality of signals or the reference value of the signal generation time lag does not limit the configuration of the signal processing of the present invention.

In the selection, the first indication location P1 or second indication location P2 of the touch input module may be included in or excluded from a region with which the finger comes into contact depending on the contact surface of the finger upon selection.

As described above, a selection by a selection means made in the selection unit of the touch input module is made within a range corresponding to the fingerprint of a single thumb.

That is, the touch execution device including the touch input module enables data execution, assigned to a specific signal (the first signal S1, the second signal S2 or the single new signal S12) generated by the selection, to be performed by the selection of the single finger.

According to the characteristics of the configuration of the touch input module, the touch execution device enables data execution, in which one or more of data input and data control are performed, to be independently or successively, easily and rapidly performed in response to an intuitive selection by the single finger 600.

The first signal S1, the second signal S2 or the single new signal S12 different from the first signal or the second signal can be successively or repeatedly generated by the successive or repetitive selection of a selection means made in the touch input module 60 of the present invention.

Referring to FIGS. 4(c) to 4(e), in a specific signal generated by the selection of a selection means made in the selection unit 100 of the touch input module, the first signal S1, the second signal S2 or the third signal S12, i.e., a single new signal, may be successively or repeatedly generated based on one side of the selection unit, the other side of the selection unit or the difference between the number of times that the single finger 600 has selected the one side and the number of times that the single finger 600 has selected the other side, which are recognized as the selection locations of the selection unit in the touch input module.

Alternatively, the first signal S1, the second signal S2 or the third signal S12, i.e., a single new signal, may be successively or repeatedly generated based on one side of the selection unit, the other side of the selection unit or the difference between the pressure of the single finger 600 applied onto the one side and the pressure of the single finger 600 applied onto the other side.

The successively or repeatedly generated signals may be previously set such that they include a plurality of first signals, a plurality of second signals or a plurality of third signals.

In this case, each of the signals be subjected to signal processing based on the reference value of a specific signal generation time lag.

That is, if the time interval of each of the first signals, the second signals or the third signals falls within the reference value, the control unit 400 processes each of the first signals, the second signals or the third signals as a new single first signal, second signal or third signal different from the first, second or third signals.

Alternatively, if the time interval of each of the first signals, the second signals or the third signals exceeds the reference value, the control unit 400 processes the first signals, the second signals or the third signals as first signals S1, S1, . . . , second signals S2, S2, . . . or third signals S12, S12, . . . generated in a plural number by independently and successively repeating the first signal, the second signal or the third signal.

As an example, if a selection by the single finger 600 is successively made at the first indication location P1 twice in the selection unit 100 of the touch input module as shown in FIG. 4(c) (SP1 is successively made twice), the first sensing region 211 including the first indication location successively comes into contact with the finger twice, and the touch sensor of the sensing unit 200 located in the first sensing region or the first region 221 of the first sensing region detects the contacts, and generates the two first signals S1 and S1.

In this case, referring to FIGS. 13(a), 14(a) and 15(c), if the time interval of each of the two first signals falls within the reference value of a specific signal generation time lag, the control unit 400 processes the two first signals as a single new first continuous signal S1-2 different from each of the two first signals S1 and S1.

That is, the control unit enables data execution, corresponding to data input in which data assigned to the first continuous signal S1-2 is input or data control in which the data is controlled, to be performed through the signal processing of the first continuous signal S1-2.

For example, referring to FIGS. 14(a) and 15(c), the data assigned to the first continuous signal S1-2 is the number “7” among the objects of the data input. That is, the control unit determines the signal according to the two successive selections, and outputs the data “7” corresponding to the determined signal S1-2 or the electrical signal of the data “7” to the electronic device 700 so that data execution regarding the data “7” is performed. In this case, the data “7” may include various functions, such as flickering, which are executed via the specific display portion 500 or indication portion 510.

Alternatively, in the embodiment in which SP1 is successively performed twice as shown in FIG. 4(c), if the time interval of each of the two first signals exceeds the reference value of a specific signal generation time lag, the control unit 400 independently and successively processes the two first signals as two first signals S1 and S1 generated from the first signal.

That is, the control unit enables data execution, corresponding to data input in which data assigned to the two first signals S1 and S1 is input or data control in which the data is controlled, to be performed through the signal processing of the two first signals S1 and S1.

For example, referring to FIGS. 13(a) and 15(c), the data assigned to the two first signals S1 and S1 is one number “1” and the other number “1” among the objects of the data input, i.e., two successive numbers “1 and 1.” That is, the control unit determines the signals based on the two successive selections, and outputs the two successive numbers “1 and 1” data corresponding to the determined signals S1 and S1 or the electrical signal of the data “1 and 1” to the electronic device 700 so that data execution regarding the data “1 and 1” is performed. In this case, the data “1 and 1” data may include various functions, such as color changing, which are executed via a specific display portion 500 or indication portion 510.

In the reference value of the specific signal generation time lag, the reference value may be set to 0.1 second, and may be set by applying the reference value of the signal generation time lag of common continuous signals. The reference value does not limit the configuration of the signal processing of the present invention.

In a specific signal generated by a selection of a selection means in the selection unit 100 of the touch input module described in the embodiment, the data assigned to the first signal S1, the second signal S2, the single new signal S12, or the third signal S12, i.e., a single new signal, may include various functions.

As one example, if a single finger continues to be located between the first indication location P1 and the second indication location P2 for a specific or longer time in the touch input module, the touch sensor of the sensing unit 200 located in a region with which the finger comes into contact may detect the contact of the finger, and may continue to generate the signal S12. In this case, the control unit 400 may process the signal S12 as invalid based on an “invalid function” set in a signal that has exceeded the specific time.

As another example, if a single finger continues to be located based on the first indication location P1 or the second indication location P2 for a specific or longer time in the touch input module, the touch sensor of the sensing unit 200 located within a region with which the finger comes into contact may detect the contact of the finger, and may continue to generate the signal S1 or the signal S2. In this case, the control unit 400 may perform signal processing so that the data execution of a short-cut function corresponding to the signal S1 or the signal S2 is performed based on the short-cut function set in a signal that has exceeded the specific time. One or more among the objects of data control including “Menu,” “Mode,” “Shortening,” “Reset,” etc. may be assigned to the short-cut function.

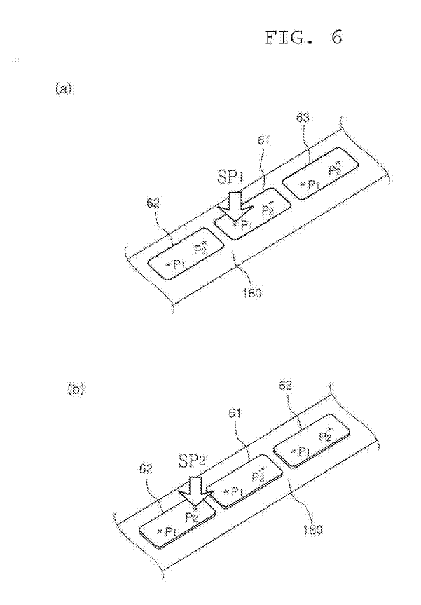

FIG. 6 is an exemplary diagram illustrating the configurations of a plurality of touch input modules and a connection frame according to an embodiment of the present invention.

Referring to FIG. 6, the touch input module 60 of the present invention may include a plurality of touch input modules.

The touch input modules may be configured to be located so that they are spaced apart from each other at specific intervals in at least one direction.

In the touch input modules, a connection frame 180 which connects one touch input module and another touch input module spaced apart from each other at a specific interval in at least one direction may be provided.

The connection frame may have at least one of a band form, a deformable form, and a detachable form.

Referring to FIG. 6(a) or 6(b), one touch input module 101 and another touch input module 102 or 103 spaced apart from each other at a specific interval in the lateral direction among touch input modules 101, 102, 103, . . . that are plural in number may be provided in a form in which they are connected by one or a plurality of connection frames.

The touch input modules 101, 102 and 103 and the connection frame 180 may be configured in various forms.

That is, as shown in FIG. 6(a), the touch input modules and the connection frame may be provided in a form in which the touch input modules have the same surface as the connection frame based on the surface of the connection frame.

Furthermore, as shown in FIG. 6(b), the touch input modules and the connection frame may be provided in a form in which the touch input modules are raised to a specific height above the surface of the connection frame based on the surface of the connection frame.

Alternatively, referring to FIG. 6(b), the touch input modules and the connection frame may be provided in a form in which the touch input modules are depressed to a specific depth below the surface of the connection frame based on the surface of the connection frame.

The connection frame may have at least one of a band form, a deformable form, and a detachable form.

For example, the deformable form may include at least one among a flexibly deformable form that is bent to a specific curvature or has a repetitive feedback property, a stepwise deformable form having a specific concave-convex shape, and an elastically deformable form that is deformed or recovered to a specific form by elasticity.

Furthermore, the detachable form may include a detachable member which enables attachment to and detachment from a specific portion of a user, or a detachable means including the detachable member. The detachable member may include one or more of a band, a ring, a latch, a guide, and Velcro.

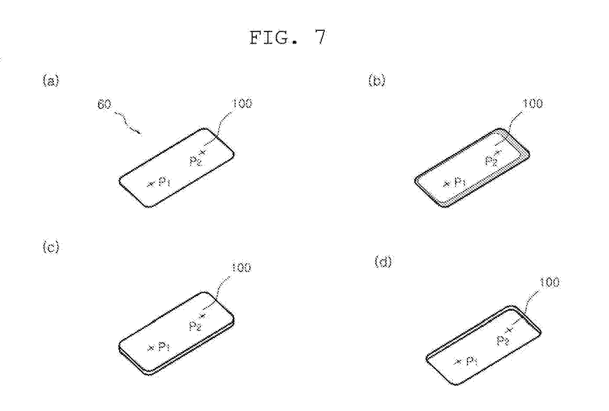

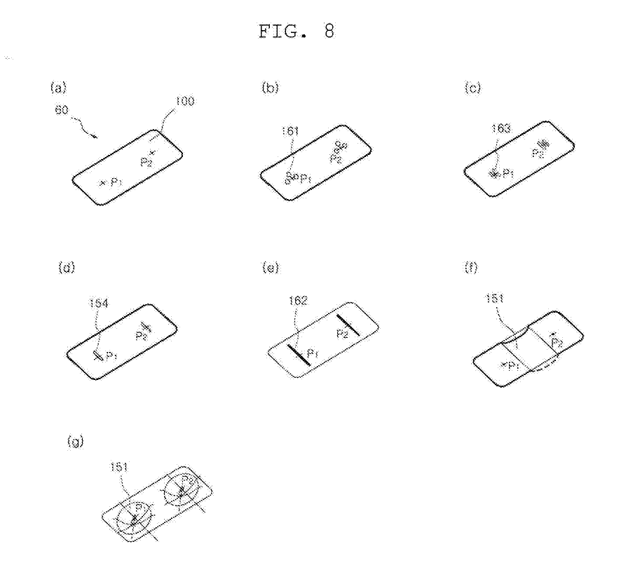

FIGS. 7 and 8 are exemplary diagrams of various configurations of the touch input module 60 according to embodiments of the present invention.

As shown in FIG. 7 or 8, the touch input module 60 may be configured in various forms.

That is, the touch input module may include at least one of a plane portion, a concave portion, and a convex portion.

Furthermore, the touch input module may be provided in a form including one or more of a quadrangle, an oval, a circle, a lozenge and a polygon. The edge of the touch input module having the shape may be entirely or partially formed to have a specific curvature.

Furthermore, the touch input module may be provided in a deformable form which is deformed to a specific form or pattern and is recovered from a deformed shape or pattern to a pattern before the deformation or which repeats deformation and recovery or in a non-deformable form other than the deformable form.

Furthermore, the touch input module may be provided in a symmetrical or asymmetrical form in one direction or a plurality of directions from a reference location or a specific location based on the reference location or the specific location.

Furthermore, the touch input module may include an assisting means for assisting the identification of a selection location at which a selection by a selection means is made. The assisting means may include at least one of a protrusion, a groove, a line, a shape, a color, shade, a sound, and light.

For example, referring to FIG. 7 or 8, the touch input module may be provided in a plane shape, as shown in FIG. 7(a) or 8(a).

Furthermore, the touch input module may be provided in a shape having specific shade, as shown in FIG. 7(b).

Furthermore, the touch input module may be provided in a shape raised to a specific height above a specific reference surface based on the reference surface, as shown in FIG. 7(c).

Furthermore, the touch input module may be provided in a shape depressed to a specific depth below a specific reference surface based on the reference surface, as shown in FIG. 7(d).

Furthermore, the touch input module may be provided in a shape having a concave portion 151 between the first indication location P1 and the second indication location P2, as shown in FIG. 8(f).

Furthermore, the touch input module or the selection unit 100 of the touch execution module may be provided as a touch means in a display form. That is, the data execution of above-described embodiments may be performed by selections by a selection means, made in the touch means, in the same manner. The touch means includes one or more of a key skin, an app, a web, an icon, an emoticon, an image, a picture, a shape, a window, and a GUI.

Referring to FIGS. 7(e) to 7(j), at least one of one side portion of the touch input module including the first sensing region 211 and the other side portion of the touch input module including the second sensing region 212 in the touch input module may be formed to have a concave part depressed from the surface of the selection unit 100 in a depth direction.

That is, the touch input module may be provided in a flat panel form (see FIG. 7(e)).

Alternatively, at least one of the one and other side portions of the touch input module may be provided in a depressed form (see FIG. 7(f) or 7(i)).

Alternatively, at least one of the one and other side portions of the touch input module may be provided in a raised form (see FIG. 7(g)).

Alternatively, the one and other side portions of the touch input module may be provided in a composite depressed and raised form (see FIG. 7(j)).

Alternatively, the one and other side portions of the touch input module may be provided in a raised concave-convex form or a depressed concave-convex form (see FIG. 7(h)).

Furthermore, unlike in the above cases, at least one of the one and other side portions of the touch input module may be formed to have a convex part raised in the height direction from the surface of the selection unit according to an embodiment of the present invention.

Referring to FIG. 8, at least one among the one and other sides of the selection unit 100 recognized as selection locations in which a selection is made by a selection means in the selection unit 100 of the touch input module 60 of the present invention and a location between the one and other sides may include at least one of a protrusion, a groove, and a concave-convex part. Alternatively, the at least one specific location may include a protrusion, a groove, and a concave-convex part. The specific location may correspond to the first indication location P1 or second indication location P2 of the touch input module or a specific location between the first indication location and the second indication location.

That is, the touch input module may include one or more protrusions 161 at a specific location at and around each of the first indication location P1 and the second indication location P2, as shown in FIG. 8(b).

Alternatively, referring to FIG. 8(b), the touch input module may include a single protrusion at each of the first indication location and the second indication location.

Furthermore, the touch input module may include one or more grooves 163 at a specific location at and around each of the first indication location P1 and the second indication location P2, as shown in FIG. 8(c).

Alternatively, referring to FIG. 8(c), the touch input module may include a single groove at each of the first indication location and the second indication location.

Furthermore, the touch input module may include a single raised portion 154 at each of the first indication location P1 and the second indication location P2, as shown in FIG. 8(d).

Alternatively, referring to FIG. 8(d), the touch input module may include one or more raised portions at a specific location at and around each of the first indication location and the second indication location.

Furthermore, the touch input module may include a single line 162 at each of the first indication location P1 and the second indication location P2, as shown in FIG. 8(e).

Alternatively, referring to FIG. 8(e), the touch input module may include one or more lines 162 at a specific location at and around each of the first indication location and the second indication location.

Furthermore, the touch input module may include a concave portion 151 at a specific portion at and around each of the first indication location P1 and the second indication location P2, as shown in FIG. 8(g).

Furthermore, referring to FIG. 8(f), the touch input module may be provided in an ergonomic form having a three-dimensional trajectory on and around a specific portion between the first indication location P1 and the second indication location P2.

Furthermore, referring to FIG. 8(g), the touch input module may be provided in an ergonomic form having a three-dimensional trajectory at and around each of the first indication location P1 and the second indication location P2.

In the various configurations of the touch input module 60 described in the embodiment of FIG. 7 or 8, the one and other sides of the touch input module may be provided in a symmetrical form or an asymmetrical form at and around the first indication location P1, the second indication location P2 or a specific location between the first indication location and the second indication location.

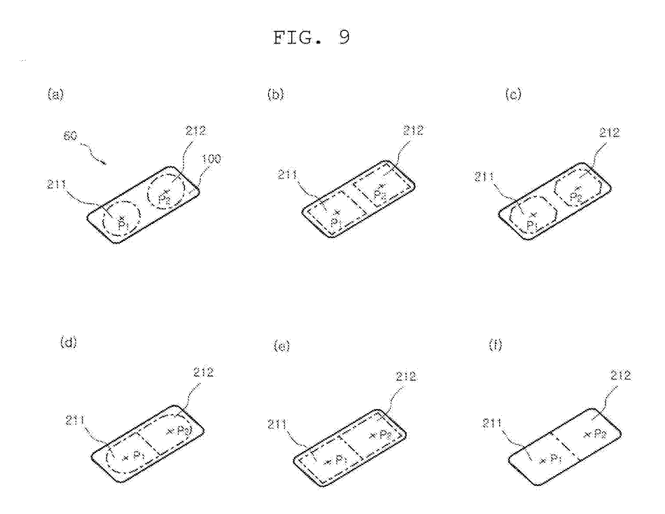

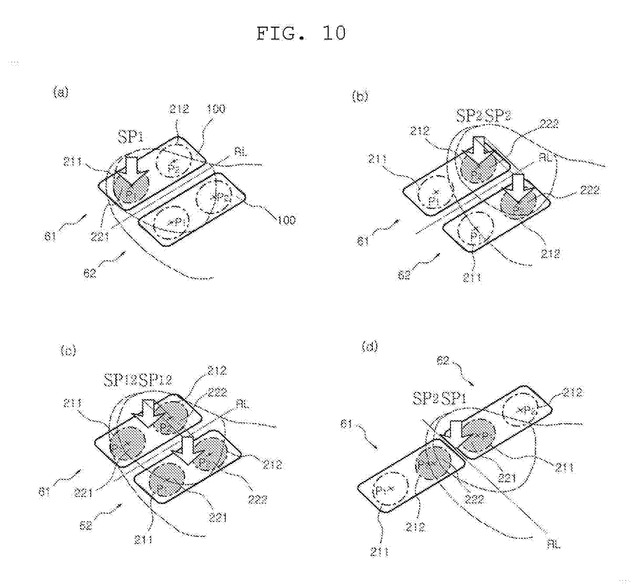

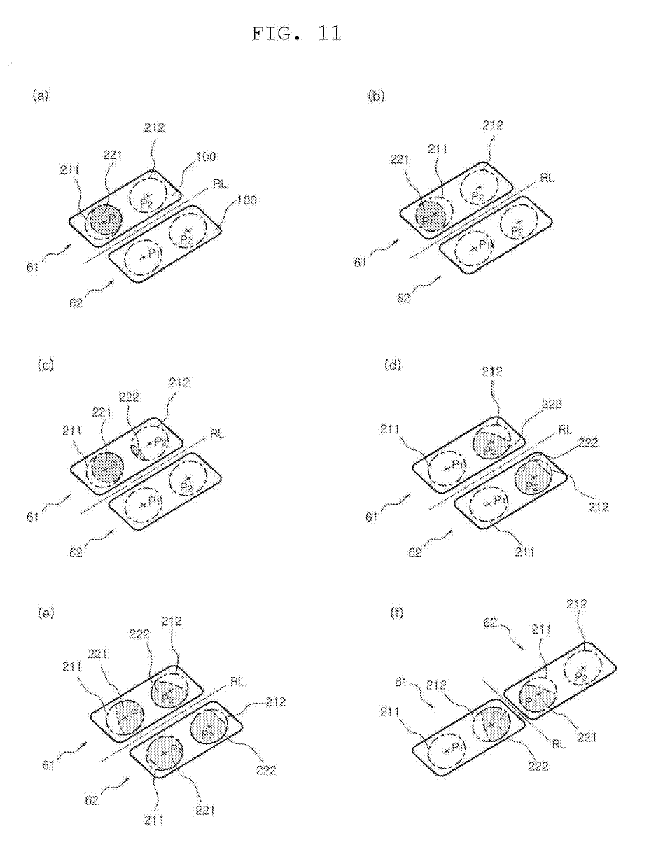

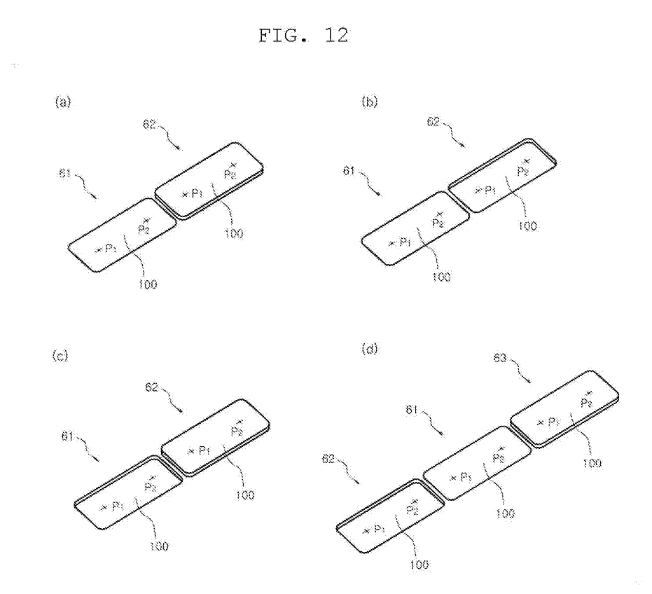

FIG. 9 is an exemplary diagram illustrating various configurations of the sensing region 210 according to embodiments of the present invention.

As shown in FIG. 9, the sensing region may be configured in various forms.

That is, as shown in FIGS. 9(a) to 9(f), the sensing region may include the first sensing region 211 of a specific size including the first indication location P1, i.e., a reference location on one side of the touch input module 60, and the second sensing region 212 of a specific size including the second indication location P2, i.e., a reference location on the other side of the touch input module.

Furthermore, as shown in FIG. 9(a), the first sensing region and the second sensing region may be provided in a circle or an oval shape.

Furthermore, as shown in FIG. 9(b) or 9(e), the first sensing region and the second sensing region may be provided in a quadrangle shape.

Furthermore, as shown in FIG. 9(c), the first sensing region and the second sensing region may be provided in a polygon shape.

Furthermore, as shown in FIG. 9(d), the first sensing region and the second sensing region may be provided in a shape partially including a specific curvature.

Furthermore, as shown in FIG. 9(d) or 9(e), the first sensing region and the second sensing region may be provided in a shape divided into the one and other side regions of the touch input module 60 or a shape partitioned into the one and side sensing regions of the touch input module.

Furthermore, as shown in FIG. 9(f), the first sensing region and the second sensing region may be provided in a shape divided into the one and other side regions of the overall touch input module 60.

In the various configurations of the sensing region 210 of FIG. 9, the first sensing region 211 and the second sensing region 212 may be provided in a symmetrical or asymmetrical shape based on the first indication location P1, the second indication location P2 or a specific location between the first indication location and the second indication location.

The sensing region of FIG. 9 is not limited to the configuration of the touch input module or the touch execution device according to the present invention.

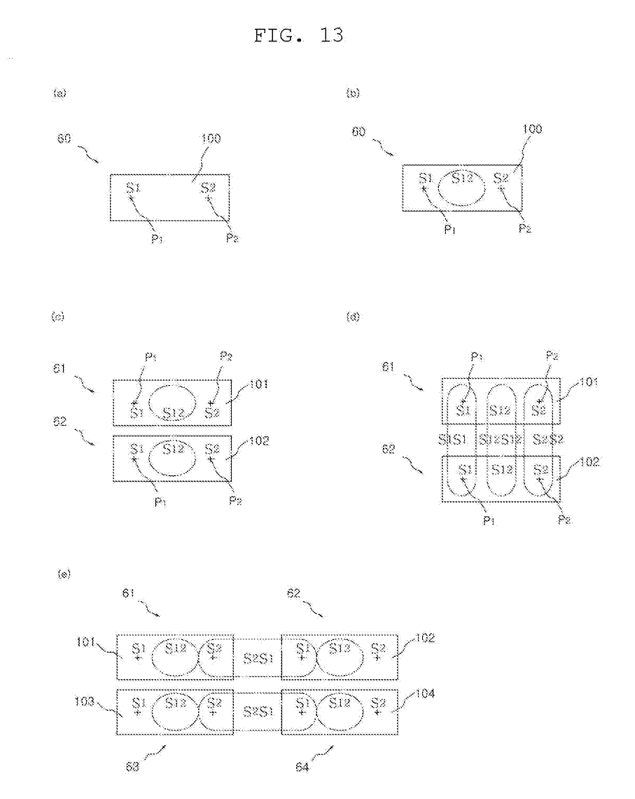

FIGS. 10 and 11 are exemplary diagrams illustrating the configurations of a plurality of the touch input modules 60 according to embodiments of the present invention, a selection made in the touch input modules, and the generation or processing of a signal by the selection.

The plurality of touch input modules may be configured in various forms.

Furthermore, the corresponding ones of the descriptions regarding a selection by a selection means, and the generation or processing of a signal by the selection, which have been given in the embodiment of FIG. 4 or 5 in the above-described embodiments, may be applied or adapted to a selection made in the plurality of touch input modules, and the generation or processing of a signal by the selection.

As an example, as shown in FIG. 10(a), the touch input module 60 of the present invention may include a first touch input module 61 and a second touch input module 62 spaced apart from each other at a specific interval in a longitudinal direction.

In this case, as shown in FIG. 10(a), when a selection by the single finger 600 is made toward the first indication location P1 of the first touch input module (SP1), the touch sensor of the sensing unit 200 located in the first region 221 of the first sensing region 211 of the first touch input module corresponding to the contact surface of the finger upon selection detects the contact of the finger, and generates the first signal S1.

In this case, as shown in FIG. 10(a), the overall first sensing region 211 of the first touch input module may correspond to the first region 221 including the first indication location P1 based on the contact surface of the finger upon selection.

Alternatively, as shown in FIG. 11(a) or 11(b) configured in the same manner as the first touch input module 61 and the second touch input module 62, a portion of the first sensing region 211 of the first touch input module may correspond to the first region 221 including the first indication location P1 based on the contact surface of the finger upon selection.

Alternatively, as shown in FIG. 10(a), the selection by the single finger 600 is made toward the first indication location P1 of the first touch input module (SP1). As shown in FIG. 11(c), portions of the first sensing region 211 and the second sensing region 212 of the first touch input module come into contact with the finger together. The touch sensors of the sensing unit 200 located in the first region 221 of the first sensing region corresponding to the contact surface of the finger upon selection and in the second region 222 of the second sensing region corresponding to the contact surface of the finger upon selection detect the contacts, and generate different signals.

In this case, as shown in FIG. 11(c), a portion of the first sensing region 211 of the first touch input module may correspond to the first region 221 including the first indication location P1, and a portion of the second sensing region 212 of the first touch input module may correspond to the second region 222, other than the second indication location P2, based on the contact surface of the finger upon selection.

In this case, the control unit 400 processes only the first signal S1 of the different signals corresponding to the signal generated by the touch sensor of the sensing unit 200 located in the first region 221 including the first indication location as a valid signal based on the predetermined setting values of a plurality of signals.

In this case, as shown in FIGS. 13(c) and 15(b), data called the “telephone” of the information communication function among the objects of data control may be previously set in the first signal S1 generated from the first touch input module by the selection.

The data execution of the telephone data by the signal processing of the first signal S1 may be performed in the same manner as in the embodiments of FIGS. 13(a) and 15(a), and thus a description thereof is omitted.

As another example, in the first touch input module 61 and the second touch input module 62 configured as shown in FIG. 10(a), when a selection by the single finger 600 is made toward the second indication location P2 of the first touch input module (SP2), the touch sensor of the sensing unit 200 located in the second region 222 of the second sensing region 212 of the first touch input module corresponding to the contact surface of the finger upon selection detects the contact of the finger, and generates the second signal S2.

In this case, the overall second sensing region 212 of the first touch input module may correspond to the second region 222 including the second indication location P2 based on the contact surface of the finger upon selection.

Alternatively, a portion of the second sensing region 212 of the first touch input module may correspond to the second region 222 including the second indication location P2 based on the contact surface of the finger upon selection.

Alternatively, a selection by the single finger 600 is made toward the second indication location P2 of the first touch input module (SP2). Portions of the second sensing region 212 and first sensing region 211 of the first touch input module come into contact with the finger together. The touch sensors of the sensing unit 200 located in the second region 222 of the second sensing region corresponding to the contact surface of the finger upon selection and the first region 221 of the first sensing region corresponding to the contact surface of the finger upon selection detect the contacts, and generate different signals.

In this case, a portion of the second sensing region 212 of the first touch input module may correspond to the second region 222 including the second indication location P2, and a portion of the first sensing region 211 of the first touch input module may correspond to the first region 221 other than the first indication location P1, based on the contact surface of the finger upon selection.

In this case, the control unit 400 processes only the second signal S2 of the different signals corresponding to the signal generated by the touch sensor of the sensing unit 200 located in the second region 222 including the second indication location as a valid signal based on the predetermined setting values of a plurality of signals.

In this case, as shown in FIGS. 13(c) and 15(b), data called the “message” of the information communication function among the objects of data control may be previously set in the second signal S2 generated from the first touch input module by the selection.

The data execution of the message data by the signal processing of the second signal S2 may be performed in the same manner as the embodiments of FIGS. 13(a) and 15(a), and thus a description thereof is omitted.

As yet another example, in the first touch input module 61 and the second touch input module 62 configured as shown in FIG. 10(a), when a selection by the single finger 600 is made toward a location between the first indication location P1 and second indication location P2 of the first touch input module (SP12), the touch sensors of the sensing unit 200 located in the first region 221 of the first sensing region 211 and the second region 222 of the second sensing region 212 of the first touch input module which have come into contact with the finger together upon selection detect the contacts, and generate different signals.

The different signals may be previously set as a single new signal S12 which is different from the first signal S1 or second signal S2 of the above-described embodiment based on the setting values of specific plural signals.

In this case, as shown in FIGS. 13(c) and 15(b), data called the “contact information” of the information communication function among the objects of data control may be previously set in the single new signal S12 generated from the first touch input module by the selection.

The data execution of the message data by the signal processing of the signal S12 may be performed in the same manner as in the embodiments of FIGS. 13(b) and 15(a), and thus a description thereof is omitted.

A selection by a selection means made in the second touch input module of the first touch input module 61 and the second touch input module 62 configured as shown in FIG. 10(a), and the generation of a signal by the selection or data execution by the signal processing are described.

As an example, in the first touch input module 61 and the second touch input module 62 configured as shown in FIG. 10(a), when a selection by the single finger 600 is made toward the first indication location P1 of the second touch input module (SP1), the touch sensor of the sensing unit 200 located in the first region 221 of the first sensing region 211 of the second touch input module corresponding to the contact surface of the finger upon selection detects the contact of the finger, and generates the first signal S1. In this case, as shown in FIGS. 13(c) and 15(b), data called the “Googling” of the search function among the objects of data control may be previously set in the first signal S1 generated from the second touch input module by the selection. That is, the control unit 400 outputs the Googling data of the search function, which has been generated and determined by the selection and which corresponds to the first signal S1 of the second touch input module or the electrical signal of the Googling data, to the electronic device so that data execution including a function regarding the “Googling” is performed. In this case, the Googling data may include various functions, such as a mobile map, which are executed via a specific display portion 500 or an indication portion 510.

As another example, in the first touch input module 61 and the second touch input module 62 configured as shown in FIG. 10(a), when a selection by the single finger 600 is made toward the second indication location P2 of the second touch input module (SP2), the touch sensor of the sensing unit 200 located in the second region 222 of the second sensing region 212 of the second touch input module corresponding to the contact surface of the finger upon selection detects the contact of the finger, and generates the second signal S2. In this case, as shown in FIGS. 13(c) and 15(b), data called the “Internet” of the information communication function among the objects of data control may be previously set in the second signal S2 generated from the second touch input module by the selection. That is, the control unit 400 outputs the Internet data of the information communication function, which has been generated and determined by the selection and which corresponds to the second signal S2 of the second touch input module or the electrical signal of the Internet data, to the electronic device so that data execution including a function regarding the “Internet” is performed. In this case, the Internet data may include various functions, such as Internet add-ons, which are executed via a specific display portion 500 or indication portion 510.

As yet another example, in the first touch input module 61 and the second touch input module 62 configured as shown in FIG. 10(a), when a selection by the single finger 600 is made toward a location between the first indication location P1 and second indication location P2 of the second touch input module (SP12), the touch sensors of the sensing unit 200 located in the first region 221 of the first sensing region 211 and the second region 222 of the second sensing region 212 of the second touch input module which have come into contact with the finger together upon selection detect the contacts, and generate different signals. The different signals may be previously set as a single new signal S12 different from the first signal S1 or second signal S2 of the above-described embodiment based on the setting values of specific plural signals. In this case, as shown in FIGS. 13(c) and 15(b), data called the “memo” of the information communication function among the objects of data control may be previously set in the single new signal S12 generated from the second touch input module by the selection. That is, the control unit 400 outputs memo data of the information communication function, which has been generated and determined by the selection and which corresponds to the signal S12 of the second touch input module or the electrical signal of the memo data, to the electronic device so that data execution regarding the “memo” is performed. In this case, the memo data may include various functions, such as memo add-ons, which are executed via a specific display portion 500 or indication portion 510.

As shown in FIG. 10(b) or 10(c), a selection by a selection means made in the first touch input module 61 and the second touch input module 62, and the generation of a signal by the selection or data execution by the signal processing may be performed in various forms.

As an example, in the first touch input module 61 and the second touch input module 62 configured as shown in FIG. 10(a), based on a single selection operation by a single thumb, when the selection is made based on a single reference line RL located between the first indication location P1 of the first touch input module and the first indication location P1 of the second touch input module (SP1SP1), the first region 221 of the first touch input module and the first region 221 of the second touch input module spaced apart from each other at a specific interval come into contact with the finger together upon selection. The touch sensors of the sensing unit 200 located in the first region of the first touch input module and the first region of the second touch input module detect the contacts, and generate different signals.

In this case, the control unit 400 processes the different signals as a single new signal S1S1, which is different from the first signal S1 generated from the first touch input module or from the first signal S1 generated from the second touch input module, based on the predetermined setting values of a plurality of signals.

In this case, as shown in FIGS. 13(d) and 15(b), data called the “camera” of the play function among the objects of data control may be previously set in the signal S1S1 generated from the first touch input module and the second touch input module by the selection.

That is, the control unit 400 outputs the camera data of the play function, which has been generated and determined by the selection and which corresponds to the signal S1S1 or the electrical signal of the camera data, to the electronic device so that data execution including a function regarding the “camera” is performed.

In this case, the camera data may include various functions, such as image or video editing, which are executed via the specific display portion 500 or indication portion 510.

As another example, as shown in FIG. 10(b), in the first touch input module 61 and the second touch input module 62 configured as shown in FIG. 10(a), based on a single selection operation by a single thumb, when the selection is made based on a single reference line RL placed between the second indication location P2 of the first touch input module and the second indication location P2 of the second touch input module (SP2SP2), the second region 222 of the first touch input module and the second region 222 of the second touch input module spaced apart from each other at a specific interval come into contact with the finger together upon selection. The touch sensors of the sensing unit 200 located in the second region of the first touch input module and the second region of the second touch input module detect the contacts, and generate different signals.

In this case, the control unit 400 processes the different signals as a single new signal S2S2, which is different from the second signal S2 generated from the first touch input module or from the second signal S2 generated from the second touch input module, based on the predetermined setting values of a plurality of signals.

In this case, as shown in FIGS. 13(d) and 15(b), data called the “camera” of the play function among the objects of data control may be previously set in the signal S2S2 generated from the first touch input module and the second touch input module by the selection.

That is, the control unit 400 outputs voice data of the play function, which has been generated and determined by the selection and which corresponds to the signal S1S1 or the electrical signal of the voice data, to the electronic device so that data execution including a function regarding the “voice” is performed.

In this case, the voice data may include various functions, such as voice add-ons, which are executed through which is executed via a specific display portion 500 or indication portion 510.

As yet another example, as shown in FIG. 10(c), in the first touch input module 61 and the second touch input module 62 configured as shown in FIG. 10(a), based on a single selection by a single thumb, when the selection is made based on a single reference line RL located between one location between the first indication location P1 and second indication location P2 of the first touch input module and one location between the first indication location P1 and second indication location P2 of the second touch input module (SP12SP12), the first region 221 and second region 222 of the first touch input module and the first region 221 and second region 222 of the second touch input module spaced apart from each other at a specific interval come into contact with the finger upon selection. The touch sensors of the sensing unit 200 located in the first region and second region of the first touch input module and the first region and second region of the second touch input module detect the contacts, and generate different signals.

In this case, the control unit 400 processes the different signals as a single new signal S12S12, which is different from the first signal S1 and the second signal S2 generated from the first touch input module or from the first signal S1 and the second signal S2 generated from the second touch input module, based on the predetermined setting values of a plurality of signals.

In this case, as shown in FIGS. 13(d) and 15(b), data called the “watch” of the information communication function among the objects of data control may be previously set in the signal S12S12 generated from the first touch input module and the second touch input module by the selection.

That is, the control unit 400 outputs the watch data of the information communication function, which has been generated and determined by the selection and which corresponds to the signal S12S12 or the electrical signal of the watch data, to the electronic device so that data execution including a function regarding the “watch” is performed.

In this case, the watch data may include various functions, such as watch add-ons, which are executed via a specific display portion 500 or indication portion 510.

Unlike in FIGS. 10(a) to 10(c), the touch input module 60 of the present invention may include the first touch input module 61 and the second touch input module 62 spaced apart from each other at a specific interval in a lateral direction, and a single reference line RL may be located between the first touch input module and the second touch input module in a longitudinal direction.

As an example, referring to FIG. 10(d), based on a single selection by a single thumb, when the selection is made based on the reference line RL located between the first indication location P1 of the first touch input module and the second indication location P2 of the second touch input module (SP1SP2), the first region 221 of the first touch input module and the second region 222 of the second touch input module spaced apart from each other at a specific interval come into contact with the finger together upon selection. The touch sensors of the sensing unit 200 located in the first region of the first touch input module and the second region of the second touch input module detect the contacts, and generate different signals.

In this case, the control unit 400 processes the different signals as a single new signal S1S2, which is different from the first signal S1 generated from the first touch input module or from the second signal S2 generated from the second touch input module, based on the predetermined setting values of a plurality of signals.

As another example, as shown in FIG. 10(d), when a selection by the single finger 600 is made based on the reference line RL located between the second indication location P2 of the first touch input module and the first indication location P1 of the second touch input module (SP2SP1), the second region 222 of the first touch input module and the first region 221 of the second touch input module spaced apart from each other at a specific interval come into contact with the finger together upon selection. The touch sensors of the sensing unit 200 located in the second region of the first touch input module and the first region of the second touch input module detect the contacts, and generate different signals.

In this case, the control unit 400 processes the different signals as a single new signal S2S1, which is different from the second signal S2 generated from the first touch input module or from the first signal S1 generated from the second touch input module, based on the predetermined setting values of a plurality of signals.

Referring to the embodiment of FIG. 10 or 11, in a selection by the single finger 600 performed in the first touch input module 61 and the second touch input module 62 of the present invention, the overall sensing region included in the touch input module may correspond to a specific region, and a portion of the sensing region may correspond to a specific region, based on the contact surface of the finger upon selection.

That is, as shown in FIG. 10, in the touch input module, the overall first sensing region 211 may correspond to the first region 221, or the overall second sensing region 212 may correspond to the second region 222, based on the contact surface of the finger upon selection.

Alternatively, as shown in FIG. 11, in the touch input module, a portion of the first sensing region 211 may correspond to the first region 221, and a portion of the second sensing region 212 may correspond to the second region 222, based on the contact surface of the finger upon selection.

In this case, as shown in FIGS. 10 and 11, the indication location P1 or P2 of the touch input module may be included in a region that belongs to the region 221 or 222 and with which the finger comes into contact upon selection, or may be excluded from the region.

The touch input module 60 of the present invention may include four touch input modules 61, 62, 63 and 64.

The four touch input modules may be provided to be spaced apart from one another at specific intervals in the direction including at least one of a lateral direction and a longitudinal direction.

As an example, the four touch input modules 61, 62, 63 and 64 may be provided in a form, such as that of FIG. 13(e).

In this case, based on a single selection by a single thumb, when the selection is made based on a single reference line RL located in the second indication location P2 of the third touch input module 63 and the first indication location P1 of the fourth touch input module 64 (SP2SP1), the second region 222 of the third touch input module and the first region 221 of the fourth touch input module spaced apart from each other at a specific interval come into contact with the finger together upon selection. The touch sensors of the sensing unit 200 located in the second region of the third touch input module and the first region of the fourth touch input module detect the contacts, and generate different signals.

In this case, the control unit 400 processes the different signals as a single new signal S2S1, which is different from the second signal S2 generated from the third touch input module or from the first signal S1 generated from the fourth touch input module, based on the predetermined setting values of a plurality of signals.

In this case, as shown in FIGS. 13(e) and 15(d), data called the “mode” of the keyboard or mouse function among the objects of data control may be previously set in the signal S2S1 generated from the third touch input module and the fourth touch input module by the selection. That is, the control unit 400 outputs the mode data of the keyboard or mouse function, which has been generated and determined by the selection and which corresponds to the signal S2S1 or the electrical signal of the mode data, to the electronic device so that data execution regarding the “mode” is performed. In this case, the mode data may include various functions, such as mode selection, mode switching, mode returning, character selection, character input, special character selection, special character input, symbol selection, symbol input, emoticon selection, emoticon input, direction selection, and direction control which are executed via the specific display portion 500 or indication portion 510.

As another example, in the four touch input modules 61, 62, 63 and 64 provided in a form, such as that of FIG. 13(e), when a selection by the single finger 600 is made between the first indication location P1 and second indication location P2 of the first touch input module 61 (SP12), the touch sensors of the sensing unit 200 located in the first region 221 and second region 222 of the first touch input module which have come into contact with the finger together upon selection detect the contacts, and generate different signals.

In this case, the control unit 400 processes the different signals as a single new signal S12, which is different from the first signal S1 generated from the first region or from the second signal S2 generated from the second region, based on the predetermined setting values of a plurality of signals.

In this case, as shown in FIGS. 13(e) and 15(g), data called the “content” of the search function among the objects of data control may be previously set in the signal S12 generated from the first touch input module by the selection. That is, the control unit 400 outputs the content data of the search function, which has been generated and determined by the selection and which corresponds to the signal S12 or the electrical signal of the content data, to the electronic device so that data execution including a function regarding the “content” is performed. In this case, the content data may include various functions, such as content add-ons, which are executed via a specific display portion 500 or indication portion 510. The objects of the content may include music, a moving image, a voice, a sound, a broadcast, a movie, a game, a character, a camera, and an image.

As yet another example, in the four touch input modules 61, 62, 63 and 64 provided in a form, such as that of FIG. 13(e), when a selection by the single finger 600 is made between the first indication location P1 and second indication location P2 of the third touch input module 63 (SP12), the touch sensors of the sensing unit 200 located in the first region 221 and second region 222 of the third touch input module that come into contact with the finger together upon selection detect the contacts, and generate different signals.

In this case, the control unit 400 processes the different signals as a single new signal S12, which is different from the first signal S1 generated from the first region or from the second signal S2 generated from the second region, based on the predetermined setting values of a plurality of signals.

In this case, as shown in FIGS. 13(e) and 15(g), data called the “start” of the motion function among the objects of data control may be previously set in the signal S12 generated from the third touch input module by the selection. That is, the control unit 400 outputs the start data of the motion function, which has been generated and determined by the selection and which corresponds to the signal S12 or the electrical signal of the start data, to the electronic device so that data execution including a function regarding the “start” is performed. In this case, the start data may include various functions, such as motion add-ons, which are executed via the specific display portion 500 or indication portion 510.

Embodiments of data execution by data input or data control which is performed in the four touch input modules 61, 62, 63 and 64 are described.

In this case, the corresponding ones of the descriptions regarding a selection by a selection means, and the generation or processing of a signal by the selection described in the embodiment of FIG. 10 in the above-described embodiments may be applied or adapted to a selection made in the plurality of touch input modules, and the generation or processing of a signal by the selection.

As an example, in data execution by data input performed in the four touch input modules 61, 62, 63 and 64 provided in a form, such as that of FIG. 13(e), data execution by input of “ [symbol] ” i.e., a Korean phoneme among the objects of data input, is described.

Referring to FIGS. 13(e) and 15(e), in the four touch input modules 61, 62, 63 and 64, when a selection by the single finger 600 is made between the first indication location P1 and second indication location P2 of the first touch input module 61 (SP12), a single new signal S12 that belongs to signals generated from the first touch input module by the selection and that is different from the first signal S1 or the second signal S2 is generated. That is, data assigned to the signal S12 is the Korean alphabetical letter “ [symbol] ,” i.e., a letter among the objects of data input.

Thereafter, when the selection is made toward the first indication location P1 of the fourth touch input module 64 (SP1), a first signal S1 is generated from the fourth touch input module by the selection. That is, data assigned to the signal S1 is the Korean alphabetical letter “ [symbol] ” i.e., a letter among the objects of data input.

In this case, the control unit 500 sequentially outputs the Korean alphabetical letter data “ [symbol] ,” which has been generated and determined by the selection and which has been assigned to the signal S12 of the first touch input module or the electrical signal of the data “ [symbol] ” and the Korean alphabetical letter data “ [symbol] ” assigned to the signal S1 of the fourth touch input module or the electrical signal of the data “ [symbol] ,” to the electronic device 700 so that data execution corresponding to the data input “ [symbol] ” in which the Korean alphabetical letters “ [symbol] ” and “ [symbol] F” have been combined is performed. In this case, the data “ [symbol] ” may be previously set such that it is displayed on the specific display portion 500 or indication portion 510.

As another example, in data execution by data input and data control performed in the four touch input modules 61, 62, 63 and 64 provided in a form, such as that of FIG. 13(e), data execution by input of the alphabetical letters “SOY” among the objects of the data input and by the control “Enter” of the keyboard function among the objects of the data control is described.

Referring to FIGS. 14(e) and 15(f), in the four touch input modules 61, 62, 63 and 64, when a selection by the single finger 600 is made toward the second indication location P2 of the third touch input module 63 (SP2), a second signal S2 is generated from the third touch input module by the selection. That is, data assigned to the signal S2 is the alphabetical letter “S” among the objects of data input.

Thereafter, when the selection is successively made on the second indication location P2 of the second touch input module 62 three times within the range of the reference value of a specific signal generation time lag (SP2 is performed three times successively), a new second signal S2-3 that belongs to signals generated from the second touch input module by the selection and that is different from the second signal S2 is generated. That is, data assigned to the signal S2-3 is the alphabetical letter “O” among the objects of data input.

Thereafter, when the selection is made toward the second indication location P2 of the fourth touch input module 64 (SP2), second signal S2 is generated from the fourth touch input module by the selection. That is, data assigned to the signal S2 is the alphabetical letter “Y” among the objects of the data input.

Thereafter, when the selection is made between the first indication location P1 and second indication location P2 of the fourth touch input module 64 (SP12), a single new signal S12 that belongs to signals generated from the fourth touch input module by the selection and that is different from the first signal S1 or the second signal S2 is generated. That is, data assigned to the signal S12 is “Enter” of the keyboard function among the objects of data control.

In this case, the control unit 500 sequentially outputs the alphabet “S” data generated and determined by the selection and assigned to the signal S2 of the third touch input module or the electrical signal of the “S” data, the alphabetical letter “O” data assigned to the signal S2-3 of the second touch input module or the electrical signal of the data “O”, the alphabetical letter data “Y” assigned to the signal S2 of the fourth touch input module or the electrical signal of the data “Y”, and the data “Enter” of the keyboard function assigned to the signal S12 of the fourth touch input module or the electrical signal of the data “Enter” to the electronic device 700 so that data execution by the data input of the alphabetical letters “SOY” and the data control of “Enter” of the keyboard function are performed. In this case, the data “SOY” may be previously set such that it is displayed on the specific display portion 500 or indication portion 510 or is controlled by the data “Enter.”

In the embodiments of FIGS. 13(e), 14(e) and 15(e), various recognition means may be added.

For example, the recognition means may include one or more of a display notification sound, flickering, a color change, a size change and a form change that enable a user to recognize a display state in which the data “ [symbol] ” or “SOY” is displayed on the display portion 500 or indication portion 510 or to recognize a display state after the display of the data “ [symbol] ” or “SOY”.

Referring to FIGS. 14(c) to 14(e), in the touch input modules 61, 62, . . . which is plural in number, a plurality of signals may be generated by the successive or repetitive selections of a selection means for a location between the indication locations P1 and P2 recognized as the selection locations of the touch input module or for a location between one indication location and the other indication location spaced apart from each other at a specific interval (a location between P1 and P1, a location between P2 and P2 or a location between P1 and P2).

The plurality of signals may be set as a plurality of first signals S1-n, a plurality of second signals S2-n, or a plurality of third signals S12-n based on the predetermined setting values of a plurality of signals (see FIG. 14).

In this case, the plurality of third signals corresponds to a plurality of signals generated from the third signal S12, i.e., a single new signal set to a signal different from the first signal S1 or from the second signal S2 according to the present invention.

For example, as shown in FIG. 14(d) or 14(e), in the selection unit 101 or 102 of the two different touch input modules 61 and 62, the third signal S12 different from the first signal S1 or the second signal S2 according to the present invention may be generated as a plurality of third signals by the successive or repetitive selections of a selection means.

In this case, the plurality of third signals may be set as S1S1-n, S2S2-n or S12S12-n, such as that of FIG. 14(d), and S2S1-n or S1S2-n, such as that of FIG. 14(e) based on the predetermined setting values of a plurality of signals. “n” shown in FIG. 14 designates the number of successive or repetitive selections by the selection means in the selection.

Furthermore, as shown in FIGS. 14(c) to 14(e), the descriptions given with reference to the embodiments of FIGS. 14(a) and 15(c) may be applied or adapted to a selection by a selection means for generating a specific signal in the plurality of touch input modules, the generation of a signal by the selection, or data execution by the signal processing, and thus detailed embodiments regarding FIGS. 14(c) to 14(e) are omitted.

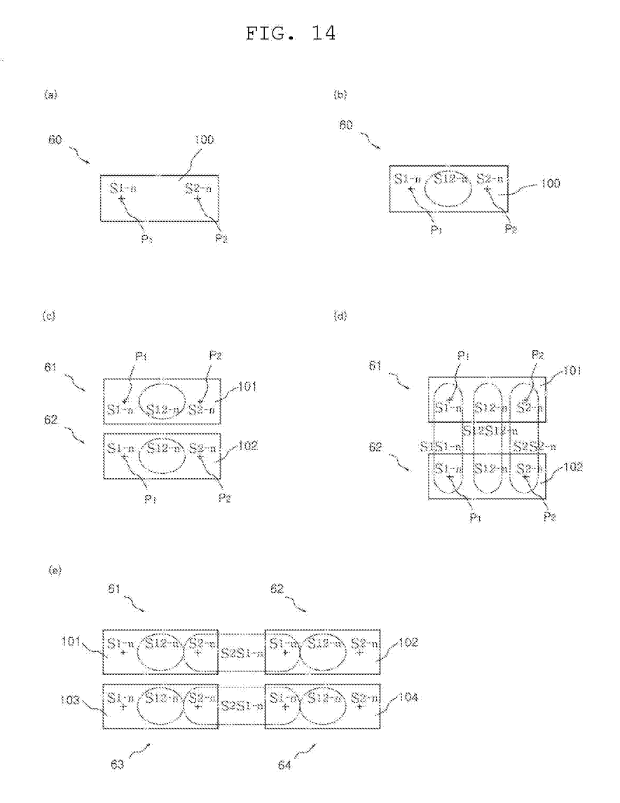

FIG. 12 is an exemplary diagram illustrating various configurations of touch input modules provided in a plural number according to embodiments of the present invention.

The touch input modules 61, 62, . . . which are plural in number may be provided in various forms.

As an example, as shown in FIG. 12(a), in the first touch input module 61 and second touch input module 62 of the touch input modules spaced apart from each other at a specific interval, the second touch input module may be provided in a form that has been raised to a specific height above the reference surface of the first touch input module based on the reference surface of the first touch input module.

Alternatively, as shown in FIG. 12(b), the second touch input module may be provided in a form that has been depressed to a specific depth below the reference surface of the first touch input module based on the reference surface of the first touch input module.

Alternatively, as shown in FIG. 12(c), based on a specific reference surface, the first touch input module may be provided in a form that has been depressed to a specific depth below the reference surface, and the second touch input module may be provided in a form that has been raised to a specific height above the reference surface.

As another example, as shown in FIG. 12(d), in the first touch input module 61, second touch input module 62 and third touch input module 63 of the touch input modules spaced apart from one another at specific intervals, based on the reference surface of the first touch input module, the second touch input module located on one side of the first touch input module may be provided in a form that has been depressed to a specific depth below the reference surface, and the third touch input module located on the other side of the first touch input module may be provided in a form that has been raised to a specific height above the reference surface.

One or more touch input modules 60 of the touch input modules which are plural in number may be provided in a form having a specific shade or pattern.

FIGS. 16 and 17 are exemplary diagrams illustrating the configurations of the touch input module 60 according to the ones of the embodiments of the present invention, which are different from that of FIG. 4 or 5, or a selection made in the touch input module.

As shown in FIG. 16(a), in the touch input module 60 of the present invention, such as that of FIG. 4(a), the sensing region 210 of the touch input module may include a first sensing region 211, a second sensing region 212 and at least one central sensing region 250 of a specific size, which correspond to the contact surface of a single finger 600.

The central sensing region is formed to have a region of a specific size between the first sensing region and the second sensing region, and is spaced apart from the first sensing region and the second sensing region at a specific interval.

When a selection by a selection means is made in the touch input module and the selection means comes into contact with the central sensing region, the touch sensor of the sensing unit 200 located in a central region 251, i.e., a region corresponding to the contact surface of the selection means that has come into contact with the central sensing region, detects the contact of the finger, and generates a specific central signal. The central signal may be previously set as a signal S12 corresponding to a single new signal which belongs to signals generated from the touch input module by the selection and which is different from a first signal S1 or a second signal S2. The single new signal may be set as a third signal S12 based on a specific signal setting value.

The descriptions given in conjunction with FIGS. 4(c) and 14(d) may be applied or adapted to selections SP1 and SP2 by the single finger 600 made in the touch input module 60, such as that of FIG. 16(c) or 16(d) or to signals (the first signal and the second signal) generated by the selection.

FIG. 16(c) or 16(d) shows a case where the central sensing region 250 has been excluded from the contact surface of the finger that has been obtained upon selection SP1 or SP2 in the touch input module.

As an example, FIG. 16(c) is an embodiment in the case where in a selection by the single finger 600 made in the selection unit 100 of the touch input module, upon selection SP1, the first region 221 has been formed in the overall first sensing region 211 including the first indication location P1 of the touch input module according to the contact surface of the finger, as shown in FIG. 4(c), but the central sensing region 250 spaced apart from the first region at a specific interval has been excluded from the contact surface of the finger.

As another example, FIG. 16(d) is an embodiment in the case where in a selection by the single finger 600 made in the selection unit 100 of the touch input module, upon selection SP2, the second region 222 has been formed in the overall second sensing region 212 including the second indication location P2 of the touch input module according to the contact surface of the finger, as shown in FIG. 4, but the central sensing region 250 spaced apart from the second region at a specific interval has been excluded from the contact surface of the finger.

Unlike in FIG. 16(c) or 16(d), in the touch input module, the central sensing region 250 or the central region 251, i.e., a region corresponding to the contact surface of the finger that has come into contact with the central sensing region, may be included in the contact surface of the finger that has been obtained upon selection SP1 or SP2.

That is, by a single selection by a single thumb in the touch input module, the first sensing region and the central sensing region, the second sensing region and the central sensing region, or the first sensing region, the second sensing region and the central sensing region may come into contact with the thumb together, and two or more different signals may be generated.

As an example, referring to FIGS. 16(c) and 17(a), by a single selection by a single finger made in the selection unit 100 of the touch input module, the first sensing region 211 and central sensing region 250 of the touch input module come into contact with the finger together. In this case, a specific control unit 400 processes only the first signal of the first signal and the central signal, generated by the ouch sensors of the sensing unit 200 located in the first region 221 of the first sensing region and the central region 251 of the central sensing region by detecting the contact, as a valid signal based on the setting values of specific plural signals.

Furthermore, in the selection, the first indication location P1 may be included in or excluded from the first region depending on the location or form of the contact surface of the finger upon selection. In this case, the above-described signal processing may be applied or adapted to the signal processing of the control unit.

As another example, referring to FIGS. 16(d) and 17(b), in a selection by the single finger 600 made in the selection unit 100 of the touch input module, the second sensing region 212 and central sensing region 250 of the touch input module may come into contact with the finger together. In this case, the control unit 400 processes only the second signal of the second signal and the central signal, generated by touch sensors of the sensing unit 200 located in the second region 222 of the second sensing region and the central region 251 of the central sensing region by detecting the contact, as a valid signal based on the setting values of specific plural signals.

Furthermore, in the selection, the second indication location P2 may be included in or excluded from the second region depending on the location or form of the contact surface of the finger upon selection. In this case, the above-described signal processing may be applied or adapted to the signal processing of the control unit.

As yet another example, referring to FIG. 16(e), a selection by the single finger 600 in the selection unit 100 of the touch input module may be performed based on a location between the first indication location P1 and second indication location P2 of the touch input module.

In this case, in the touch execution module, the first sensing region 211, the second sensing region 212 and the central sensing region 250 that have come into contact with the finger together upon selection may come into contact with the finger together. The touch sensors of the sensing unit 200 located in the first region 221 of the first sensing region, the second region 222 of the second sensing region and the central region 251 of the central sensing region detect the contacts, and generate different signals. The different signals may be configured to be set to a single new signal different from the first signal S1, second signal S2 or central signal of the above-described embodiment. That is, the single new signal may be set to S12 different from the signal S1 or the signal S2 based on the setting values of specific plural signals.

Alternatively, in the signal processing of the first signal, the second signal and the central signal, the control unit 400 may process only the central signal of the signals as a valid signal based on the predetermined setting values of a plurality of signals.

Furthermore, in the selection, the first indication location P1 may be included in or excluded from the first region and the second indication location P2 may be included in or excluded from the second region depending on the location or form of the contact surface of the finger upon selection. In this case, the above-described signal processing may be applied or adapted to the signal processing of the control unit.

The corresponding ones of the descriptions given with reference to FIG. 4 or 5 may be applied or adapted to the signal processing of the signals generated in the embodiment of FIG. 16 or 17 or data execution by the signal processing.

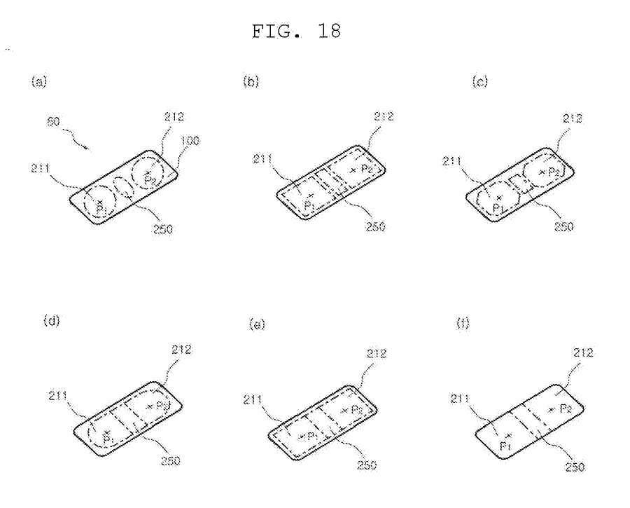

FIG. 18 is an exemplary diagram of various configurations of the sensing region 210 according to the ones of the embodiments of the present invention, which are different from that of FIG. 9.

As shown in FIGS. 18(a) to 18(f), the sensing region may include the first sensing region 211 of a specific size including the first indication location P1, i.e., a reference location on one side of the touch input module 60, the second sensing region 212 of a specific size including the second indication location P2, i.e., a reference location on the other side of the touch input module, and at least one central sensing region 250 of a specific size located between the first sensing region and the second sensing region which are spaced apart from each other at a specific interval from the first indication location and the second indication location, respectively.

As shown in FIG. 18(a), the first sensing region, the second sensing region and the central sensing region may be provided in a circle or an oval shape.

As shown in FIG. 18(b), the first sensing region, the second sensing region and the central sensing region may be provided in a quadrangle shape.

As shown in FIG. 18(c), the first sensing region, the second sensing region and the central sensing region may be provided in a polygon shape.

As shown in FIG. 18(d), the first sensing region, the second sensing region and the central sensing region may be provided in a shape partially including a specific curvature.

As shown in FIG. 18(d) or 18(e), the first sensing region, the second sensing region and the central sensing region may be provided in a shape divided into a region on one side of the touch input module 60, a region on the other side of the touch input module, and a region between the one-side region and the other-side region or in a shape partitioned into a sensing region on one side of the touch input module, a sensing region on the other side of the touch input module, and a sensing region between the one-side sensing region and the other-side sensing region.

As shown in FIG. 18(f), the first sensing region, the second sensing region and the central sensing region may be provided in a shape partitioned into a region on one side of the overall touch input module 60, a region on the other side thereof, and a region between the one-side region and the other-side region thereof.

In the various configurations of the sensing region 210 of FIG. 18, based on the first indication location P1, the second indication location P2m or a specific location between the first indication location and the second indication location, the first sensing region, the second sensing region and the central sensing region may be provided in a symmetrical or asymmetrical shape.

Furthermore, based on a specific location between the first indication location and the second indication location or based on the center of the central sensing region, the central sensing region may be provided in the form of a plurality of partitioned sensing regions, or may be formed as a plurality of sensing regions.

The sensing region of FIG. 18 is not limited to the configuration of the touch input module or the touch execution device according to the present invention.

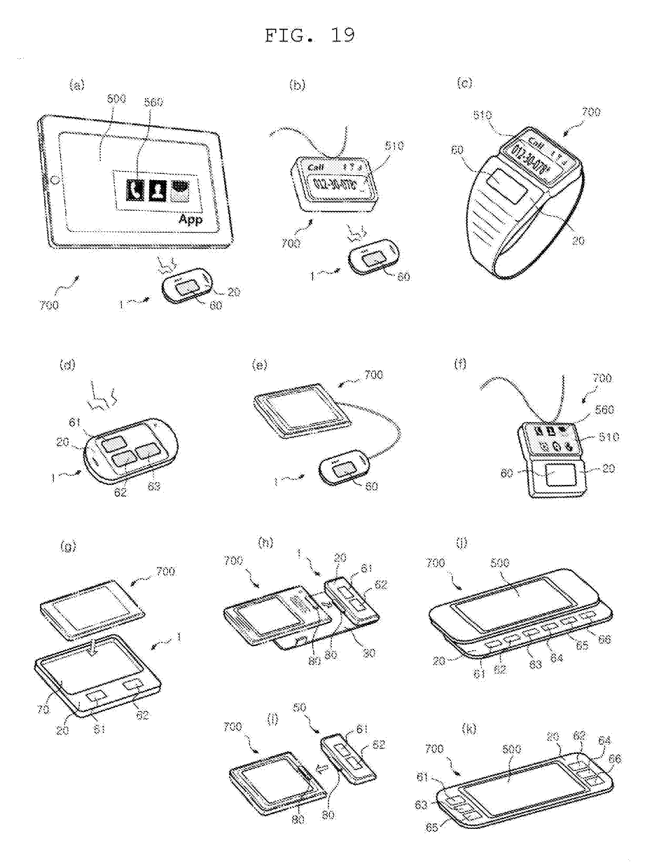

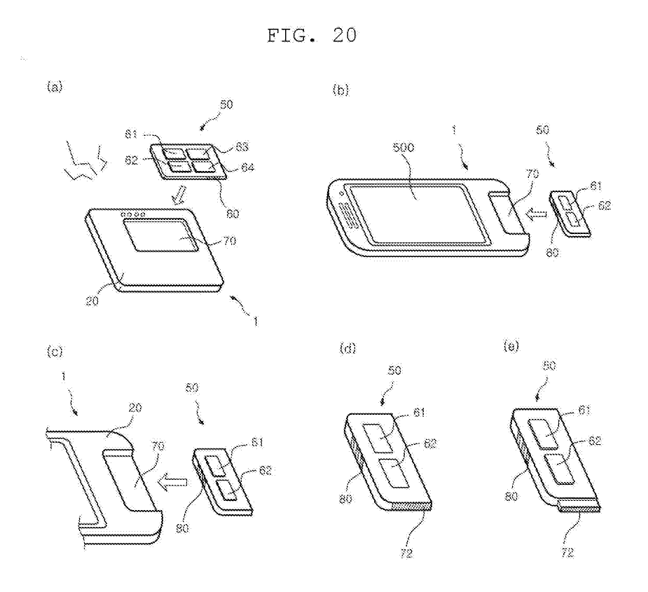

FIGS. 19 and 20 are exemplary diagrams illustrating various configurations of the touch input module 60 or touch execution device 1 according to the present invention.

The touch input module may be provided at a specific location of the electronic device 700 to which the touch execution device is applied. Alternatively, the selection unit 100 of the touch input module may be provided to be displayed on the display portion 500 or the indication portion 510. Alternatively, the display portion or the indication portion may be formed in at least one of the touch input module, the touch execution device and the electronic device.

As an example, the touch input module may be provided in the main body 20 of the touch execution device 1.

That is, as shown in FIG. 19(a), when a specific object is displayed on the display portion 500 of the electronic device configured by applying the touch execution device to the electronic device, data execution in which one or more of data input and data control assigned to data previously set in the object are performed may be independently or successively performed by a selection by a single finger made in the touch input module.

The corresponding description of the signal processing of the signal S1, S2 or S12 generated by the selection of a selection means, which has been given with reference to the embodiment 1 of the present invention, may be applied or adapted to the data execution regarding the object (a telephone, a message or contact information) shown in FIG. 19(a).

As another example, the touch input module may be provided in the main body 20 of the electronic device.

That is, as shown in FIG. 19(c) or 19(f), when a specific object is displayed on the indication portion 510 of the electronic device configured by applying the touch execution device to the electronic device, data execution in which one or more of data input and data control assigned to data previously set in the object are independently or successively performed may be performed by a selection by a single finger made in the touch input module.

The corresponding description of the signal processing of the signal S1, S2 or S12 generated by the selection of a selection means, which has been given with reference to the embodiment 1 of the present invention, may be applied or adapted to the data execution regarding the object (a telephone, a message, contact information, start, the Internet, or a moving image) shown in FIG. 19(f).

As yet another example, the touch input module may be provided in the touch execution device or the main body 20 of the electronic device.

That is, as shown in FIG. 19(b) or 19(c), when a specific object is displayed on the indication portion 510 of the electronic device configured by applying the touch execution device, including the touch input module, to the electronic device or by applying the touch input module, data execution in which one or more of data input and data control assigned to data previously set in the object are performed may be independently or successively performed by a selection by a single finger made in the touch input module.

The corresponding description of the signal processing of the signal S1, S2 or S12 generated by the selection of a selection means, which has been given with reference to the embodiment 1 of the present invention, may be applied or adapted to data execution regarding the object (a number, a character or a symbol) shown in FIG. 19(b) or 19(c).

One or more touch input modules may be applied and configured at a specific location of the touch execution device.

That is, as shown in FIG. 19(d), 19(g) or 19(h), one or more touch input modules 61, . . . may be provided in the main body 20 of the touch execution device.

The touch input module may be applied and configured at a specific location of the electronic device in the form of one or more touch input modules.

That is, as shown in FIG. 19(j) or 19(k), the touch input module may be applied and configured in the main body 20 of the electronic device in the form of one or more touch input modules 61, . . . .

Referring to FIG. 19(e), the touch execution device 1 or the touch input module 60 may be configured along with a specific electronic device 700 in a wired manner.

Referring to FIG. 19(a), 19(b) or 19(d), the touch execution device 1 or the touch input module 60 may be configured along with a specific electronic device 700 in a wirelessly manner.

That is, the touch execution device and the electronic device, or the touch input module and the electronic device may be provided to transfer specific signals, including the first signal S1, the second signal S2 and the single new signal S12 according to an embodiment of the selection of a selection means of the present invention, or to transfer the transfer signal of data allocated to the specific signal, via transmission/reception means. The transmission/reception means may include RF, Bluetooth, IrDA, ZigBee, SWAP, Wi-Fi, Li-Fi means, etc.

Referring to FIG. 19(g), the touch execution device 1 or the touch input module 60 may be configured in an encased form along with the electronic device 700.

For example, referring to the arrow shown in FIG. 19(g), a detachable unit 70 including detachable means for selectively attach and detect the touch execution device and the electronic device to and from each other is formed at one or more specific locations of the main body 20 of the touch execution device or the electronic device.

The detachable means includes a detachable member.

That is, the detachable member may include one or more of a protrusion, a groove, a slot, a guide, a latch, a holder, a ring, a band, and Velcro.

Furthermore, the detachable member may include at least one of a concave portion, a concave portion, a wing portion, a raised portion, and a composite portion. The composite portion may include one or more of wrinkles, a concave-convex part, and a zigzag pattern.

Furthermore, the detachable member may include a member having a repetitive feedback property which supports or maintains the attachment of the touch execution device and the electronic device to each other, enables the detachment of the touch execution device and the electronic device from each other to be easily performed, and enables the attachment and detachment to be repeatedly performed, in the attachment and detachment of the touch execution device and the electronic device to and from each other.

The member having the repetitive feedback property may include a flexible member which performs feedback at a specific curvature or an elastic member which performs feedback at a specific modulus of elasticity.

Referring to FIG. 19(h), the touch execution device 1 may be configured in a detachable form along with the electronic device 700.

For example, referring to the arrow shown in FIG. 19(h), in the configuration of the detachable form, a terminal 80 in a specific form may be provided in the form of a means for enabling the attachment/detachment to be performed. The terminal may be formed at one or more specific locations of the touch execution device or the electronic device. The terminal may be provided to transfer a specific signal, including the first signal S1, the second signal S2 and the single new signal S12 generated from the touch execution device or the touch input module 60 included in the touch execution device according to the present invention, or to transfer the transfer signal of data assigned to the signal.

In FIG. 19(h), the touch execution device may include a holder 30 of a specific form which easily supports or maintains coupling with the electronic device.

Referring to FIG. 19(c), the touch input module 60 or the touch execution device 1 may be applied to the electronic device 700 of a wearable form including a wrist-wearable form or a glasses form, or may be configured in the electronic device.

Referring to FIG. 19(b) or 19(f), the touch input module 60 or the touch execution device 1 may be applied to the electronic device 700 of a wearable form including a necklace form or a ring form or may be configured in the electronic device.

Referring to FIG. 19(j), the touch input module 60 or touch execution device 1 may be applied to the electronic device 700 having a sliding form including a multi-direction type, a folding type or a rotating type, or may be configured in the electronic device.

Referring to FIG. 19(k), the touch input module 60 or touch execution device 1 may be applied to the electronic device 700 having a single frame form including a flat panel type, a flexible type or a deformable type, or may be configured in the electronic device.

Referring to FIGS. 13(c) to 13(e) or FIGS. 14(c) to 14(e), the selection unit 100 according to the present invention may be provided in the form of a plurality of selection units 101, 102, . . . . The selection units may be provided to be spaced apart from one another at specific intervals in at least one direction. The selection units may be provided at specific locations of the touch execution device 1 or electronic device 700.

As shown in FIG. 19(i) or 20, the touch input module 60 of the present invention may be included in an interface unit 50 having a specific form, or may be configured at a specific location of the interface unit.

The interface unit may be provided in various forms in which a selection by a selection means is made and a specific signal according to the present invention is generated by the selection.

That is, as shown in FIG. 19(i), the interface unit 50 and a specific electronic device 700 may be provided to be selectively attached and detached to and from each other.

Alternatively, as shown in FIG. 20, the interface unit 50 and a specific touch execution device 1 may be provided to be selectively attached and detached to and from each other.

In this case, referring to the arrow shown in FIG. 19(i), a detachable means for enabling the interface unit and the electronic device to be selectively attached and detached to and from each other may be provided at one or more specific locations of the interface unit and the electronic device.

Alternatively, referring to the arrows shown in FIGS. 20(a) to 20(c), a detachable unit 70 including a detachable means for enabling the interface unit and the touch execution device to be attached and detached to and from each other may be provided at one or more specific locations of the interface unit and the main body 20 of the touch execution device.

Furthermore, referring to FIG. 20(d) or 20(e), the detachable means includes a detachable member 72.

The corresponding descriptions of the embodiment of FIG. 19(g) may be applied or adapted to the detachable means, the detachable unit or the detachable member.

Referring to FIG. 19(i) or 20, the touch input module may be provided at a specific location of the interface unit in the form of one or more touch input modules 61, . . . .

As shown in FIGS. 20(a) to 20(c), if the interface unit 50 and a specific touch execution device 1 are provided to be detachable, the interface unit and the touch execution device may be provided to transfer a specific signal, including the first signal S1, the second signal S2 and the single new signal S12 according to the present invention, or to transfer the transfer signal of data allocated to the signal via transmission/reception means. The transmission/reception means may include a means using a wireless method or a means using a wired method, including RF, Bluetooth, IrDA, ZigBee, SWAP, Wi-Fi, Li-Fi means, etc.

Referring to FIG. 20, a terminal 80 may be provided at one or more specific locations of the interface unit 50 and the touch execution device 1. The terminal may be provided to transfer a specific signal, including the first signal S1, the second signal S2 and the single new signal S12 generated from the interface unit or the touch execution device, or to transfer the transfer signal of data assigned to the signal. Furthermore, the terminal may function as a detachable means for enabling the interface unit and the touch execution device to be selectively attached and detached to and from each other. The corresponding descriptions of the embodiment of FIG. 19(g) may be applied or adapted to the detachable means, the detachable unit 70 included in the detachable means, or the detachable member 72.

The touch input module or the touch execution device may be easily applied or configured in a hardware execution device or a software execution device based on the characteristics of the touch input module 60 or touch execution device 1 of the present invention described with reference to the above-described embodiments.

That is, according to the present invention, at least one touch input module included in the touch execution device has a structure in which it includes different sensing regions including respective indication locations spaced apart from each other at a specific interval within a range corresponding to the fingerprint of a single thumb on the one and other sides of the touch input module and a selection by a selection means made at or in one or more indication locations or sensing regions of the sensing regions is made within the range corresponding to the fingerprint. Accordingly, advantages arise in that in the touch input module, three different types of data execution are performed in the selection of each case where the indication location is performed once in the selections based on the indication locations (one indication location located on one side of the touch input module within a region with which the fingerprint of a single thumb comes into contact, and the other indication location located on the other side of the touch input module) and data execution in which one or more of data input and data control are performed can be independently or successively, easily and rapidly performed by the intuitive selection of the one or more indication locations or sensing regions by the single finger.

Furthermore, the selection of one or more of the indication locations or different sensing regions including the respective indication locations can be performed by the intuitive selection operation of a single finger because the indication locations spaced apart from each other at a specific interval in the touch input module of the present invention are located within a region with which the fingerprint of the single thumb comes into contact. Accordingly, advantages arise in that the frequency of erroneous manipulations can be decreased in the successive or repetitive selection operations of one or more of the indication locations or sensing regions by a finger and a benefit in use is achieved in that the accumulation of fatigue on the finger or the generation of stress is suppressed.

Furthermore, an advantage arises in that data execution by a selection can be naturally performed even in the state of being moved or moving because the selection of the indication locations spaced apart from each other at a specific interval in the touch input module of the present invention or different sensing regions including the respective indication locations is easily and rapidly performed through a soft touch by a single finger.

Furthermore, the touch input module or the touch execution device of the present invention can be easily applied to various types of electronic devices including a wearable device, a variable device, an Internet of Things (IoT) device, a composite device, etc., or can be easily configured in the form of a detachable or portable accessory in each of the electronic devices. Accordingly, the touch input module or the touch execution device has an advantage in industrial applicability, in which an improved environment or opportunity for data execution is provided to a user.

That is, according to the above characteristics of the present invention, a user can have the advantage of considerably improving or increasing usability, convenience and industrial applicability in the field of electronic devices in which one or more of data input and data control are performed through data execution using the touch input module or the touch execution device.

The above-described embodiments of the present invention are merely some of various embodiments of the present invention. Furthermore, it will be apparent that various embodiments included in the technical spirit of at least one touch input module of the present invention—the touch input module is provided such that three different types of data execution are performed in each selection in which the selection of an indication location by a selection means is made once based on one indication location located on one side of the touch input module and the other indication location located on the other side of the touch input module within a region with which the fingerprint of a single thumb comes into contact —or a touch execution device included in the touch input module are included in the range of protection of the present invention.

### INDUSTRIAL APPLICABILITY

The present invention relates to a touch execution device. The touch execution device of the present invention includes at least one touch input module having the selection unit which enables a selection by a selection means to be performed within a region corresponding to the fingerprint of a single thumb, and two different sensing regions (the first sensing region and the second sensing region) in the touch input module are provided on one axis in one direction that passes through the sensing regions so that they correspond to the contact surface of the finger upon selection respectively or collectively. Accordingly, the two sensing regions in each of which a specific signal is generated in response to a selection made in the selection unit are characterized in that they are recognized as three different selection locations (the selection location on one side of the selection unit, the selection location on the other side of the selection unit, and a selection correspondence location between the one and other sides) on the contact surface of the single thumb at and around the center of the sensing regions by three selection operations each of which is performed on the sensing regions once based on a single selection operation performed by a single thumb.

That is, in the present invention, the two sensing regions are naturally recognized as three different selection locations on a contact surface of a single thumb touched based on the center of the sensing regions. Accordingly, the selection for the selection locations according to the recognition is performed by the intuitive selection operation of a single finger without separate learning, and thus data execution in which one or more of data input and data control are performed by a familiar movement of the finger for the selection locations can be easily and rapidly performed.

Furthermore, the present invention can be easily applied to various types of electronic devices including a wearable device, a variable device, an Internet of Things (IoT) device, a composite device, etc., or can be easily configured in the form of a detachable or portable accessory in the electronic devices.

The present invention including the above features is an invention having high industrial applicability in that it can provide further various device configurations or a more improved environment for data execution to a user in electronic devices in which input, output or input/output are executed.

1. A touch execution device using a thumb, which is provided such that a selection by a selection means including a finger is made in a selection unit and data execution assigned to a signal generated by detection of a contact upon selection is performed, the touch execution device comprising:
at least one touch input module including a selection unit configured to enable the selection to be made by a single finger, and a sensing unit provided to generate the signal in response to the selection;
wherein in the touch input module:
the selection unit is provided in a specific size within a range capable of corresponding to a fingerprint of the single thumb;
the sensing unit includes a sensing region provided to generate a specific signal through detection of a contact of the finger upon selection, and the sensing region includes a first sensing region and a second sensing region formed to have regions each having a specific width and length on one and remaining sides of the touch input module, respectively, and located to face each other;
based on a single thumb located at a central portion of the selection unit in the touch input module, a first indication location which is a reference location of the first sensing region and a second indication location which is a reference location of the second sensing region are located within a range in which the first indication location and the second indication location come into contact with a fingerprint of the thumb together, and the first indication location and the second indication location are respectively recognized as a selection location on one side of the selection unit and a selection location on an a remaining side of the selection unit which are spaced apart from each other at a specific interval on one axis in one direction which passes through the first sensing region and the second sensing region and, simultaneously, are recognized as an interval selection location corresponding to a selection of a location between the one and other sides by the thumb;
based on a single selection operation performed by a single thumb in the touch input module:
when the selection is made based on the first indication location, the touch sensor of the sensing unit located in a first region of the first sensing region corresponding to the contact surface of the thumb upon selection detects a contact of the thumb including a contact at the first indication location, and generates a first signal;
when the selection is made based on the second indication location, the touch sensor of the sensing unit located in a second region of the second sensing region corresponding to the contact surface of the thumb upon selection detects a contact of the thumb including a contact at the second indication location, and generates a second signal; and
when the selection is made based on a location between the first indication location and the second indication location, the touch sensors of the sensing unit located in the first region and the second region which have come into contact with the thumb together upon selection detect a contact of the thumb including contacts at the first indication location and the second indication location and generate different signals, and the different signals are set as a single new signal different from the first signal or the second signal; and
data execution assigned to the first signal, the second signal or the single new signal generated by the selection is independently or successively performed.

2. The touch execution device of claim 1, wherein:
based on a single selection operation performed by a single thumb in the touch input module:
in the generation of the first signal by the selection, the second indication location is spaced apart from the first indication location at a specific interval outside the contact surface of the thumb which has come into contact with the first region including the first indication location located at a center of the first sensing region; and
in the generation of the second signal by the selection, the first indication location is spaced apart from the second indication location at a specific interval outside the contact surface of the thumb which has come into contact with the second region including the second indication location located at a center of the second sensing region.

3. The touch execution device of claim 1, wherein in the touch input module, the first sensing region and the second sensing region are provided to correspond to the contact surface of the finger upon selection individually or collectively.

4. The touch execution device of claim 1, wherein:
based on a single selection operation by a single thumb in the touch input module, when the first sensing region and the second sensing region are selected together by the thumb:
in the selection, when the first indication location has been included in a region with which the thumb has come into contact and the second indication location has been excluded from the region, the touch sensors of the sensing unit located in the first region and the second region are provided to detect the contact and generate different signals; and a specific control unit is provided to process only the first signal of the different signals, corresponding to a signal generated by the touch sensor of the sensing unit located in the first region including the first indication location, as a valid signal based on predetermined setting values of a plurality of signals; or
in the selection, when the second indication location has been included in a region with which the thumb has come into contact and the first indication location has been excluded from the region, the touch sensors of the sensing unit located in the second region and the first region are provided to detect the contacts and generate different signals; and the control unit is provided to process only the second signal of the different signals, corresponding to a signal generated by the touch sensor of the sensing unit located in the second region including the second indication location, as a valid signal based on the setting values of a plurality of signals.

5. The touch execution device of claim 1, wherein in the touch input module, at least one of a one side portion of the touch input module including the first sensing region and a remaining side portion of the touch input module including the second sensing region is formed to be depressed to a specific depth in a depth direction below the surface of the selection unit.

6. The touch execution device of claim 1, wherein the sensing unit includes at least one of a touch pad and a touch screen.

7. The touch execution device of claim 1, wherein in the touch input module, at least one of one and remaining sides of the selection unit and at least one predetermined location between the one and remaining sides includes at least one of a protrusion, a groove and, a concave-convex part.

8. The touch execution device of claim 1, wherein:
in a signal generated by the selection in the touch input module:
in a plurality of first signals, a plurality of second signals or a plurality of third signals successively generated from the first signal, the second signal or a third signal which is the single new signal based on a difference in a number of selections of the one side of the selection unit, the remaining side of the selection unit or a location between the one and remaining sides a single thumb:
when a time interval of each of the first signals, the second signals and the third signals is within a reference value of a specific signal generation time lag based on the reference value, a specific control unit processes the first signals, the second signals and the third signals as a single new first signal, a single new second signal, and a single new third signal, respectively, which are different from the first signal, the second signal, and the third signal; and
when the time interval of each of the first signals, the second signals and the third signals exceeds the reference value, the control unit processes the first signals, the second signals and the third signals as a plurality of first signals, a plurality of second signals, and a plurality of third signals independently successively generated from the first signal, the second signal, and the third signal, respectively.

9. The touch execution device of claim 1, wherein:
the touch input module includes a plurality of touch input modules; and
the touch input modules are spaced apart from each other at a specific interval in at least one direction.

10. The touch execution device of claim 9, wherein:
the touch input module includes a first touch input module and a second touch input module spaced apart from each other at a specific interval in a longitudinal direction;
a single reference line is located in a lateral direction between the first touch input module and the second touch input module; and
based on a single selection operation performed by a single thumb, when the selection is made based on the reference line located between the first indication location of the first touch input module and the first indication location of the second touch input module:
the first region of the first touch input module and the first region of the second touch input module spaced apart from each other at a specific interval come into contact with the thumb together upon selection;
the touch sensors of the sensing unit located in the first region of the first touch input module and the first region of the second touch input module detect the contacts and generate different signals; and
a specific control unit processes the different signals as a single new signal, different from the first signal generated from the first touch input module or the first signal generated from the second touch input module, based on predetermined setting values of a plurality of signals.

11. The touch execution device of claim 10, wherein:
in the touch input module, based on a single selection operation performed by a single thumb,
when the selection is made based on the reference line located between the second indication location of the first touch input module and the second indication location of the second touch input module:
the second region of the first touch input module and the second region of the second touch input module spaced apart from each other at a specific interval come into contact with the thumb together upon selection;
the touch sensors of the sensing unit located in the second region of the first touch input module and the second region of the second touch input module detect the contacts and generate different signals; and
the control unit processes the different signals as a single new signal, different from the second signal generated from the first touch input module or the second signal generated from the second touch input module, based on the setting values of a plurality of signals.

12. The touch execution device of claim 10, wherein:
in the touch input module, based on a single selection operation by a single thumb,
when the selection is made based on the reference line located between one location between the first indication location and second indication location of the first touch input module and one location between the first indication location and second indication location of the second touch input module:
the first region and second region of the first touch input module and the first region and second region of the second touch input module spaced apart from each other at a specific interval come into contact with the finger together upon selection;
the touch sensors of the sensing unit located in the first region and second region of the first touch input module and the first region and second region of the second touch input module detect the contacts and generate different signals; and
the control unit processes the different signals as a single new signal, different from the first signal and the second signal generated from the first touch input module or the first signal and the second signal generated from the second touch input module, based on the setting values of a plurality of signals.

13. The touch execution device of claim 9, wherein:
the touch input module includes a first touch input module and a second touch input module spaced apart from each other at a specific interval in a lateral direction;
a single reference line is located in a longitudinal direction between the first touch input module and the second touch input module; and
based on a single selection operation by a single thumb, when the selection is made based on the reference line located between the first indication location of the first touch input module and the first indication location of the second touch input module:
the first region of the first touch input module and the first region of the second touch input module spaced apart from each other at a specific interval come into contact with the thumb together upon selection;
the touch sensors of the sensing unit located in the first region of the first touch input module and the first region of the second touch input module detect the contacts and generate different signals; and
a specific control unit processes the different signals as a single new signal, different from the first signal generated from the first touch input module or the first signal generated from the second touch input module, based on predetermined setting values of a plurality of signals.

14. A touch execution device using a thumb, which is provided such that a selection by a selection means including a finger is performed in a selection unit and data execution assigned to a signal generated by detection of a contact upon selection is performed, the touch execution device comprising:
at least one touch input module including a selection unit configured to enable the selection to be performed by a single finger and a sensing unit provided to generate the signal in response to the selection;
wherein, in the touch input module:
the selection unit is provided in a specific size within a range corresponding to a fingerprint of the single thumb;
the sensing unit includes a sensing region provided to generate a specific signal through detection of a contact of the finger upon selection, and the sensing region includes a first sensing region and a second sensing region formed to have regions each having a specific width and length on one and remaining sides of the touch input module, respectively, and located to face each other;
based on a single thumb located at a central portion of the selection unit in the touch input module, a first indication location which is a reference location of the first sensing region and a second indication location which is a reference location of the second sensing region are located within a range in which the first indication location and the second indication location come into contact with a fingerprint of the thumb together, and the first indication location and the second indication location are respectively recognized as a selection location on one side of the selection unit and a selection location on an other side of the selection unit which are spaced apart from each other at a specific interval on one axis in one direction which passes through the first sensing region and the second sensing region and, simultaneously, are recognized as an interval selection location corresponding to a selection of a location between the one and remaining sides by the thumb;
at least one central sensing region having a region of a specific size is further formed between the first sensing region and the second sensing region, and the central sensing region is spaced apart from the first sensing region and the second sensing region at a specific interval;
based on a single selection operation by a single thumb in the touch input module:
when the selection is made based on the first indication location, the touch sensor of the sensing unit located in a first region of the first sensing region corresponding to the contact surface of the thumb upon selection detects a contact of the thumb including a contact at the first indication location, and generates a first signal;
when the selection is made based on the second indication location, the touch sensor of the sensing unit located in a second region of the second sensing region corresponding to the contact surface of the thumb upon selection detects a contact of the thumb including a contact at the second indication location, and generates a second signal; and
when the selection is made based on a location between the first indication location and the second indication location;
the touch sensors of the sensing unit located in the first region and the second region which have come into contact with the thumb together and in a central region which is a region corresponding to the contact surface of the thumb which has come into contact with the central sensing region upon selection detect a contact of the thumb including the contacts at the first indication location and the second indication location and generate different signals, and the different signals are set as a single new signal different from the first signal, the second signal or a central signal generated by the contact of the central region; and
data execution assigned to the first signal, the second signal or the single new signal generated by the selection is independently or successively performed.

15. The touch execution device of claim 14, wherein:
when the first sensing region and the central sensing region, the second sensing region and the central sensing region, or the first sensing region, the second sensing region and the central sensing region come into contact with the thumb together and two or more different signals are generated by a single selection by a single thumb in the touch input module:
a specific control unit:
processes only the first signal of the first signal and the central signal, which have been generated by the touch sensors of the sensing unit located in the first region and the central region, other than the first indication location, through sensing of the contacts, as a valid signal;
processes only the second signal of the second signal and the central signal, which have been generated by the touch sensors of the sensing unit located in the second region and the central region, other than the second indication location, through sensing of the contacts, as a valid signal; or
processes the first signal, the second signal and the central signal, which have been generated by the touch sensors of the sensing unit located in the first region other than the first indication location, the second region other than the second indication location, and the central region through sensing of the contacts, as a single new signal different from the first signal, second signal or central signal.

16. The touch execution device of claim 1, wherein the touch input module includes at least one of a plane portion, a concave portion, and a convex portion.

17. The touch execution device of claim 1, wherein:
an assisting means adapted to assist identification of a selection location where the selection is made is provided in the touch input module; and
the assisting means includes at least one of a protrusion, a groove, a line, a shape, a color, shade, a sound, and light.

18. The touch execution device of claim 9, wherein:
a connection frame configured to connect one touch input module and another touch input module spaced apart from each other at a specific interval in at least one direction is provided in the touch input modules; and
the connection frame has at least one of a band shape, a detachable shape, and a deformable shape.

19. The touch execution device of claim 1, wherein:
the touch input module is provided at a specific location of an electronic device to which the touch execution device is applied;
the selection unit of the touch input module is provided to be displayed on a display portion or an indication portion; or
the display portion or the indication portion is formed in at least one of the touch input module, the touch execution device, and the electronic device.

20. The touch execution device of claim 1, wherein:
the touch input module is included in an interface unit having a specific shape;
the selection is made in the interface unit, and the signal is generated by the selection; and
the interface unit and the touch execution device are provided to be detachable from each other.

21. The touch execution device of claim 20, wherein:
a detachable means configured to enable the interface unit and the touch execution device to be attached or detached to and from each other includes a detachable member; and
the detachable member includes one or more of a protrusion, a groove, a slot, a guide, a latch, a holder, a ring, a band, Velcro, and a member having a repetitive feedback property.

22. The touch execution device of claim 20, wherein:
a terminal is provided at one or more specific locations of the interface unit and the touch execution device; and
the terminal transfers a signal generated from the interface unit or the touch execution device, or transfers a transfer signal of data assigned to the signal.

23. The touch execution device of claim 1, wherein:
the selection unit is provided in a form of a plurality of selection units; and
the selection units are spaced apart from each other at a specific interval in at least one direction.
